(19) United States
(12) Patent Application Publication
(10) Pub. No.: US 2023/0057079 A1
(43) Pub. Date: Feb. 23, 2023

(54) FAILURE DETECTION APPARATUS AND RADAR APPARATUS WITH FAILURE DETECTION APPARATUS

(71) Applicant: Mitsubishi Electric Corporation, Tokyo (JP)

(72) Inventors: Takuya TANIGUCHI, Tokyo (JP); Yuichi GODA, Tokyo (JP); Yukihiro TAHARA, Tokyo (JP)

(73) Assignee: Mitsubishi Electric Corporation, Tokyo (JP)

(21) Appl. No.: 17/797,337

(22) PCT Filed: Mar. 26, 2020
(86) PCT No.: PCT/JP2020/013541

§ 371 Date: Aug. 3, 2022

(51) Int. Cl. G01S 7/40; G01S 13/931

(52) U.S. Cl. CPC G01S 7/4091; G01S 13/931

(57) ABSTRACT

A conventional millimeter wave radar cannot detect a failure when there is not satisfied the condition that a road exists in front of a vehicle or that in two or more radar apparatuses, a leakage electric wave from another radar can be detected. A failure detection apparatus according to the present disclosure calculates reception power values from a reception processing signal for each antenna and compares the reception power value with a reference power value determined by a reference power calculation unit so as to perform a failure determination. There is provided a failure determination unit that compares the reference power value for a failure determination with the power value obtained from a reception processing signal outputted from each of receivers so as to perform a failure determination for each of the receivers.

### TECHNICAL FIELD

The present application relates to a failure detection apparatus and a radar apparatus provided with the failure detection apparatus.

### BACKGROUND ART

A vehicle-mounted radar apparatus has been utilized to date for detecting an obstacle, i.e., detecting an object so as to prevent the vehicle from colliding with an obstacle such as a telephone pole or a block, for example, at a time when the vehicle is garaged. In addition, a vehicle-mounted radar apparatus has been utilized also for measuring a distance between an own vehicle and a preceding vehicle thereof and then following the preceding vehicle so as to prevent a rear-end accident. Such a vehicle-mounted radar apparatus needs to perform failure detection in order to determine whether or not a detection output is reliable.

In the conventional failure detection by a radar, a failure can be detected only under limited conditions related to the state of a vehicle, a surrounding situation, the installation condition of the radar, and the like, as conditions for detecting a failure, such as that the vehicle is travelling on a road, that a road surface reflecting a radar wave exists in front, and that the radar collaborates with another radar. However, in order to prevent a failure in the radar from causing a problem in the vehicle, it is required to detect the failure no matter under which condition the vehicle exists.

### CITATION LIST

### Patent Literature

Patent Document 1: Specification of Japanese Patent No. 4045043

Patent Document 2: Japanese Patent Application Laid-Open No. 2006-047052

Patent Document 3: Japanese Patent Application Laid-Open No. 2008-203148

Patent Document 1 discloses a technology in which a failure in a millimeter wave radar is detected by detecting a low-intensity reflection signal from a road surface. However, for example, in the case where no road surface exists in front of a vehicle, i.e., in the case where the vehicle is surrounded by a wall, in the case where a parking place is surrounded by a field or a river, or in the case where a parking place faces an ocean, no failure can be detected.

Patent Document 2 discloses a technology in which a failure is detected by comparing a Doppler shift with an own-vehicle speed. In this case, when a vehicle is in a stop state, no Doppler shift is generated; thus, this technology cannot be utilized. In order to detect a failure, it is indispensable that the vehicle is in a traveling state.

Patent Document 3 discloses a technology in which each of two or more radars receives a leakage electric wave from another radar so as to detect an abnormality. Because being based on detection of a leakage electric wave from another radar, this technology cannot be applied to a radar apparatus that cannot detect a leakage electric wave from another radar.

Therefore, failure detection for a radar can be performed by existing technologies only under the condition that a road exists in front of a vehicle, that a vehicle is in a moving state, or that in two or more radar apparatuses, a leakage electric wave from another radar can be detected.

### SUMMARY OF INVENTION

Thus, the objective of the present application is to obtain a failure detection apparatus that can detect a failure even when there is not satisfied the condition that a road exists in front of a vehicle, that a vehicle is in a moving state, or that in two or more radar apparatuses, a leakage electric wave from another radar can be detected.

### Solution to Problem

A verification apparatus according to the present disclosure includes

two or more reception antennas,

two or more receivers that are provided for the respective reception antennas and process respective signals received by the reception antennas so as to generate respective reception processing signals, and

a failure determination unit that compares a reference power value for a failure determination with a power value obtained from a reception processing signal outputted from each of receivers so as to perform a failure determination for each of the receivers.

### Advantage of Invention

A verification apparatus according to the present disclosure makes it possible that failure detection for a radar is performed even when there is not satisfied the condition that a road exists in front of a vehicle, that a vehicle is in a moving state, or that in two or more radar apparatuses, a leakage electric wave from another radar can be detected.

### BRIEF DESCRIPTION OF THE DRAWINGS

FIG. 1 is a block diagram representing a millimeter wave radar according to Embodiment 1;

FIG. 2 is a block diagram representing a failure detection apparatus in the millimeter wave radar according to Embodiment 1;

FIG. 3 is a hardware configuration diagram representing the failure detection apparatus in the millimeter wave radar according to Embodiment 1;

FIG. 4 is a set of charts representing reception processing signals of the millimeter wave radar according to Embodiment 1;

FIG. 5 is a flowchart for explaining failure-detection processing according to Embodiment 1;

FIG. 6 is a block diagram representing a failure detection apparatus in a millimeter wave radar according to Embodiment 2;

FIG. 7 is a flowchart for explaining failure-detection processing according to Embodiment 2;

FIG. 8 is a table for explaining a relationship between reception power values and reference power values according to Embodiment 2;

FIG. 9 is a block diagram representing a failure detection apparatus in a millimeter wave radar according to Embodiment 3;

FIG. 10 is a flowchart for explaining failure-detection processing according to Embodiment 3;

FIG. 11 is a block diagram representing a failure detection apparatus in a millimeter wave radar according to Embodiment 4;

FIG. 12 is a flowchart for explaining failure-detection processing according to Embodiment 4;

FIG. 13 is a block diagram representing a failure detection apparatus in a millimeter wave radar according to Embodiment 5;

FIG. 14 is a flowchart for explaining failure-detection processing according to Embodiment 5;

FIG. 15 is a block diagram representing a failure detection apparatus in a millimeter wave radar according to Embodiment 6;

FIG. 16 is a flowchart for explaining failure-detection processing according to Embodiment 6;

FIG. 17 is a block diagram representing a failure detection apparatus in a millimeter wave radar according to Embodiment 7;

FIG. 18 is a flowchart for explaining failure-detection processing according to Embodiment 7;

FIG. 19 is a block diagram representing a failure detection apparatus in a millimeter wave radar according to Embodiment 8;

FIG. 20 is a flowchart for explaining failure-detection processing according to Embodiment 8;

FIG. 21 is a block diagram representing a failure detection apparatus in a millimeter wave radar according to Embodiment 9;

FIG. 22 is a chart representing a power spectrum of a reception processing signal in the millimeter wave radar according to Embodiment 9;

FIG. 23 is a table representing power values, for frequencies, of the reception processing signal in the millimeter wave radar according to Embodiment 9; and

FIG. 24 is a flowchart for explaining failure-detection processing according to Embodiment 9.

### DESCRIPTION OF EMBODIMENTS

Hereinafter, embodiments of the present disclosure will be explained with reference to the drawings.

### 1. Embodiment 1

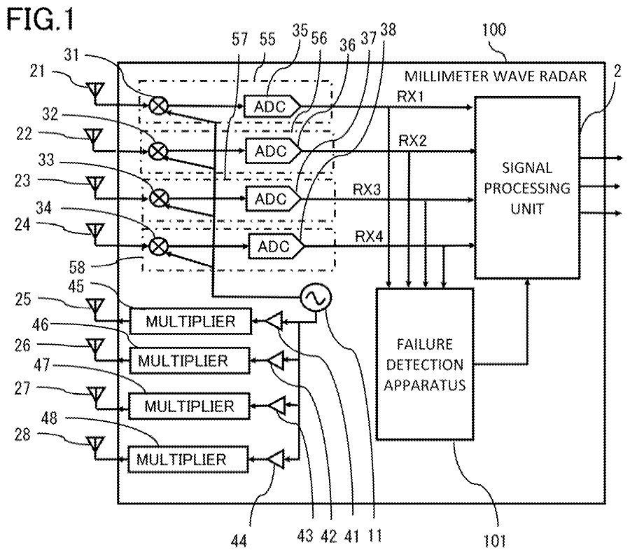

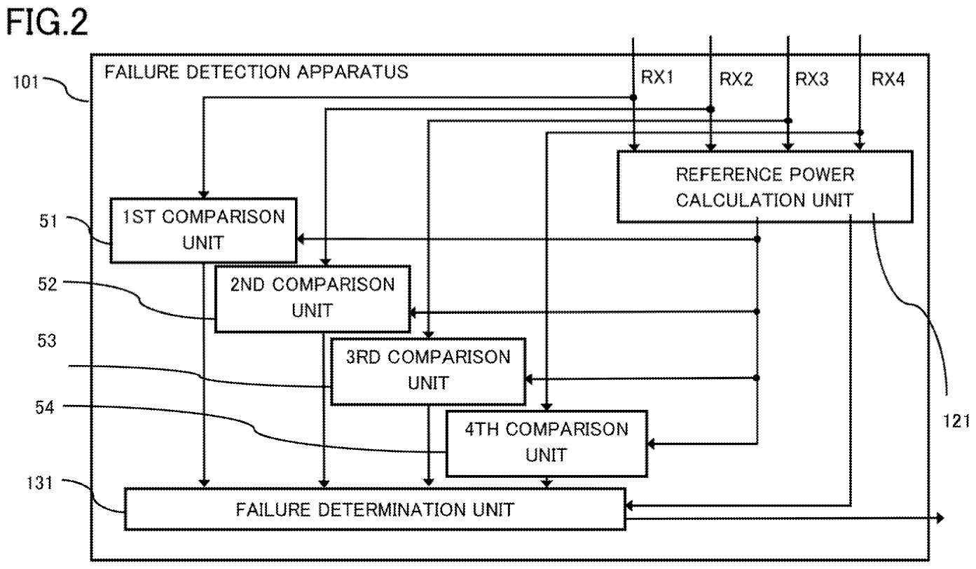

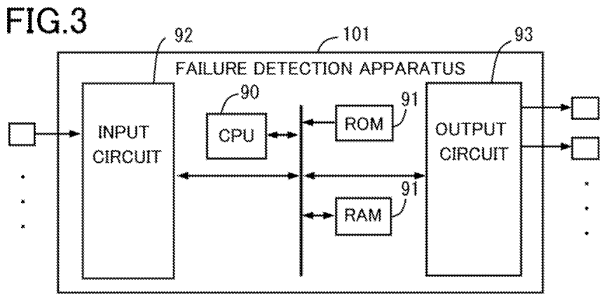

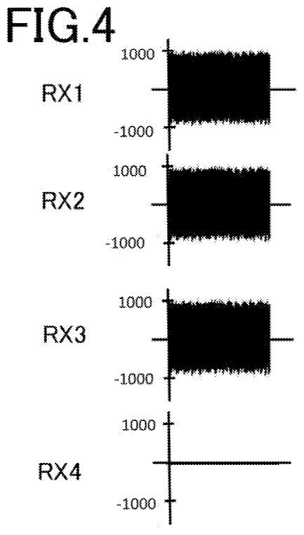

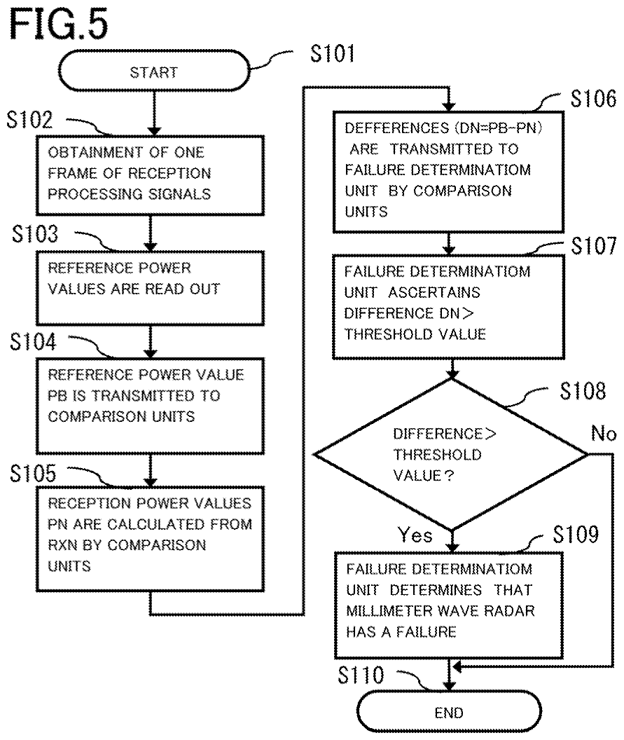

A failure detection apparatus 101 according to Embodiment 1 will be explained. FIG. 1 is a block diagram representing a millimeter wave radar 100 according to Embodiment 1. FIG. 2 is a block diagram representing the failure detection apparatus 101 in the millimeter wave radar 100 according to Embodiment 1. FIG. 3 is a hardware configuration diagram representing the failure detection apparatus 101 in the millimeter wave radar according to Embodiment 1. FIG. 4 is a set of charts representing reception signals of respective antennas of the millimeter wave radar 100 according to Embodiment 1. FIG. 5 is a flowchart for explaining failure-detection processing according to Embodiment 1.

### <Millimeter Wave Radar>

FIG. 1 is a block diagram representing the millimeter wave radar 100. The millimeter wave radar has a first transmission antenna 25, a second transmission antenna 26, a third transmission antenna 27, and a fourth transmission antenna 28 for emitting electric waves. The millimeter wave radar has a first reception antenna 21, a second reception antenna 22, a third reception antenna 23, and a fourth reception antenna 24 for receiving electric waves. In the case where there exists an object that reflects an electric wave forward, respective electric waves emitted from the first to fourth transmission antennas 25, 26, 27, and 28 are received by the first to fourth reception antennas 21, 22, 23, and 24, after a delay time in which the respective electric waves shuttle between the object and the millimeter wave radar. The millimeter wave radar is an apparatus that compares a received signal with an emitted signal so as to localize the position of an object that reflects an electric wave and to determine the speed of the object.

A signal generated by a modulation signal generator 11 is amplified by a first amplifier 41, a second amplifier 42, a third amplifier 43, and a fourth amplifier 44; the amplified signals are each converted into respective high-frequency waves by a first multiplier 45, a second multiplier 46, a third multiplier 47, and a fourth multiplier 48; then, the high-frequency waves are each emitted, as electric waves, from the first to fourth transmission antennas 25, 26, 27, and 28. The reflected electric waves are received by the first to fourth reception antennas 21, 22, 23, and 24; by way of a first mixer 31, a second mixer 32, a third mixer 33, and a fourth mixer 34, the mixed signals are each digitized by a first A/D converter 35, a second A/D converter 36, a third A/D converter 37, and a fourth A/D converter 38. The first mixer 31 and the first A/D converter 35 are collectively referred to as a first receiver 55; the second mixer 32 and the second A/D converter 36 are collectively referred to as a second receiver 56; the third mixer 33 and the third A/D converter 37 are collectively referred to as a third receiver 57; the fourth mixer 34 and the fourth A/D converter 38 are collectively referred to as a fourth receiver 58. A first reception processing signal RX1, a second reception processing signal RX2, a third reception processing signal RX3, and a fourth reception processing signal RX4 outputted from the first to fourth receivers 55, 56, 57, and 58, respectively, are each taken into a signal processing unit 2 and the failure detection apparatus 101. The signal processing unit 2 performs calculation for determining the position of a reflecting object and the like; the failure detection apparatus 101 determines whether or not there exists a failure in the first to fourth receivers 55, 56, 57, and 58.

### <Failure Detection Apparatus>

FIG. 2 is a block diagram representing the failure detection apparatus 101 in the millimeter wave radar 100. The failure detection apparatus 101 is configured in such a way as to input the first to fourth reception processing signals RX1, RX2, RX3, and RX4 obtained by processing the signals from the first to fourth reception antennas 21, 22, 23, and 24 by the first to fourth receivers 55, 56, 57, and 58. The first to fourth reception processing signals RX1, RX2, RX3, and RX4 are inputted to a reference power calculation unit 121 for determining reference power value PB as a reference for failure determination. The reference power calculation unit 121 obtains first reception power value P1, second reception power value P2, third reception power value P3, and fourth reception power value P4 from the first to fourth reception processing signals RX1, RX2, RX3, and RX4 outputted from the first to fourth receivers 55, 56, 57, and 58. The reference power calculation unit 121 calculates the reference power value PB, based on the first to fourth reception power values P1, P2, P3, and P4 obtained from the first to fourth reception processing signals RX1, RX2, RX3, and RX4.

The reference power calculation unit 121 calculates the reference power value PB and then transmits it to a first comparison unit 51, a second comparison unit 52, a third comparison unit 53, and a fourth comparison unit 54. The first to fourth comparison units 51, 52, 53, and 54 obtain the first to fourth reception power values P1, P2, P3, and P4 from the first to fourth reception processing signals RX1, RX2, RX3, and RX4 outputted from the first to fourth receivers 55, 56, 57, and 58, compare the reference power value PB with the respective reception power values P1, P2, P3, and P4, and then transmit a first power difference D1, a second power difference D2, a third power difference D3, and a fourth power difference D4 to a failure determination unit 131. The failure determination unit 131 compares a predetermined threshold value DT with the respective differences D1, D2, D3, and D4 between the reference power value PB and the respective reception power values P1, P2, P3, and P4 for the reception processing signals RX1, RX2, RX3, and RX4 so as to determine a failure in the first to fourth receivers of the millimeter wave radar 100. The failure detection apparatus 101 outputs a determination result to the outside. The failure in this case includes not only a failure in the first to fourth receivers 55, 56, 57, and 58 of the millimeter wave radar 100 but also a failure in the first to fourth reception antennas 21, 22, 23, and 24.

In Embodiment 1, a case where the number of the reception antennas is four is described; however, the number of the reception antennas may be arbitrary, as long as it is the same as or larger than 2. In that case, the millimeter wave radar 100 has a configuration in which the respective numbers of the amplifiers, the multipliers, the transmission antennas, the reception antennas, the receivers, and the comparison units and the respective numbers of signal inputs and signal outputs are increased or decreased. In addition, in Embodiment 1, as a specific example, a millimeter wave radar has been explained; however, the failure detection apparatus 101 can also be applied to a radar utilizing a microwave; the frequency of the electric wave to be utilized in a radar is not restricted.

### <Hardware Configuration of Failure Detection Apparatus>

FIG. 3 is a hardware configuration diagram representing the failure detection apparatus 101 in the millimeter wave radar 100. It may be allowed that the failure detection apparatus is included in the hardware configuration of the millimeter wave radar 100. In that case, the millimeter wave radar 100 has the following hardware configuration; concurrently, the failure detection apparatus 101 also has the following hardware configuration.

Respective functions of the failure detection apparatus 101 are realized by processing circuits provided in the failure detection apparatus 101. Specifically, as illustrated in FIG. 3, the failure detection apparatus 101 includes, as the processing circuits, a computing processing unit (computer) 90 such as a CPU (Central Processing Unit), storage apparatuses 91 that exchange data with the computing processing unit 90, an input circuit 92 that inputs external signals to the computing processing unit 90, an output circuit 93 that outputs signals from the computing processing unit 90 to the outside, and the like.

It may be allowed that as the computing processing unit 90, an ASIC (Application Specific Integrated Circuit), an IC (Integrated Circuit), a DSP (Digital Signal Processor), an FPGA (Field Programmable Gate Array), each of various kinds of logic circuits, each of various kinds of signal processing circuits, or the like is provided. In addition, it may be allowed that as the computing processing unit 90, two or more computing processing units of the same type or different types are provided and respective processing items are executed in a sharing manner. As the storage apparatuses 91, there are provided nonvolatile or volatile semiconductor memories such as a RAM (Random Access Memory) that can read data from and write data in the computing processing unit 90, a ROM (Read Only Memory) that can read data from the computing processing unit 90, a flash memory, an EPROM, an EEPROM. The input circuit 92 is connected with various kinds of sensors and switches and is provided with an A/D converter and the like for inputting output signals from the sensors and the switches to the computing processing unit 90. The output circuit 93 is connected with electric loads and is provided with a driving circuit and the like for converting and outputting a control signal from the computing processing unit 90 to the electric loads. In addition, each of the input circuit 92 and the output circuit 93 has a serial communication circuit. The failure detection apparatus 101 also includes a function in which a signal, to be transmitted as a serial signal, is received by the input circuit 92 and then is stored in the storage apparatus 91 and in which a signal read out from the storage apparatus 91 is processed by the computing processing unit 90 and then is serially outputted from the output circuit 93.

The computing processing unit 90 runs software items (programs) stored in the storage apparatus 91 such as a ROM and collaborates with other hardware devices in the failure detection apparatus 101, such as the storage apparatus 91, the input circuit 92, and the output circuit 93, so that the respective functions provided in the failure detection apparatus 101 are realized. Setting data items such as a threshold value and a determination value to be utilized in the failure detection apparatus 101 are stored, as part of software items (programs), in the storage apparatus 91 such as a ROM.

The respective functions of the constituent elements in failure detection apparatus 101 in FIG. 2 will be explained. It may be allowed that the reference power calculation unit 121, the failure determination unit 131, and the respective functions indicated by the first to fourth comparison units 51, 52, 53, and 54, described inside the failure detection apparatus 101 in FIG. 2, are configured with either software modules or combinations of software and hardware.

### <Example of Reception Processing Signal>

FIG. 4 represents the first to fourth reception processing signals RX1, RX2, RX3, and RX4 that are outputted by the first to fourth receivers 55, 56, 57, and 58, after respective signals are received from the first to fourth reception antennas 21, 22, 23, and 24 of the millimeter wave radar 100. FIG. 4 represents the case where the fourth reception processing signal RX4, outputted by the fourth receiver 58 that has received a signal from the fourth reception antenna 24, is abnormal. The first to third reception processing signals RX1, RX2, and RX3, which are the outputs of the first to third receivers that have received the respective signals from the first to third reception antennas 21, 22, and 23, are normally outputted.

### <Determination of Reference Power Value and Failure Determination>

The method in which the reference power calculation unit 121 determines the reference power value PB will be described. The first to fourth reception processing signals RX1, RX2, RX3, and RX4 outputted by the first to fourth receivers 55, 56, 57, and 58 are inputted to the reference power calculation unit 121. The first to fourth reception power values P1, P2, P3, and P4 corresponding to the first to fourth reception processing signals RX1, RX2, RX3, and RX4, respectively, are calculated; then, based on the first to fourth reception power values P1, P2, P3, and P4, the reference power value PB is calculated. For example, the reference power calculation unit 121 can determine the reference power value PB, based on the average value, the median value, the maximum value, or the like of the first to fourth reception power values P1, P2, P3, and P4. Alternatively, for the reception processing signal of the receiver to be verified, the reference power calculation unit 121 can also determine the reference power value PB, based on the average value, the median value, the maximum value, or the like of the respective reception power values obtained from the reception processing signals of the other three receivers. Moreover, for the reception processing signal of the receiver to be verified, by directly utilizing, as the reference power values PB, respective reception power values obtained from the reception processing signals of the other three receivers, the reference power calculation unit 121 can perform the comparison one by one, totally thrice, so as to perform the determination.

The first to fourth comparison units 51, 52, 53, and 54 of the failure detection apparatus 101 obtain the first to fourth reception power values P1, P2, P3, and P4 from the first to fourth reception processing signals RX1, RX2, RX3, and RX4 transmitted from the first to fourth receivers 55, 56, 57, and 58, and then compare the reference power value PB with the respective reception power values P1, P2, P3, and P4. The first to fourth comparison units 51, 52, 53, and 54 transmit the first difference D1, the second difference D2, the third difference D3, and the fourth difference D4, which are the respective comparison results, to the failure determination unit 131. The first difference D1, the second difference D2, the third difference D3, and the fourth difference D4 are each calculated from the equation “Dn=PB−Pn (n=1 through 4)”. When the respective compared reception power values P1, P2, P3, and P4 are larger than the reference power value PB, the first difference D1, the second difference D2, the third difference D3, and the fourth difference D4 become negative values; when the respective compared reception power values P1, P2, P3, and P4 are smaller than the reference power value PB, the first difference D1, the second difference D2, the third difference D3, and the fourth difference D4 become positive values. In the case where the transmitted difference Dn is larger than the threshold value DT, the failure determination unit 131 determines that the receiver that has outputted the reception processing signal RXn has a failure. For example, even in the case where no road surface exists in front of a vehicle, such as where the vehicle surrounded by a wall, where a parking place is surrounded by a field or a river, or where a parking place faces an ocean, in the case where a reflected wave is weak, or in the case where no object that emits a reflected wave exists, a signal including noise from surroundings that is received through a reception antenna exists and hence the reception power for the reception signal can be calculated. In contrast, in the case where a receiver has a failure, the reception processing signal to be outputted therefrom is largely different from the reception processing signals RX1 through RX3 to be outputted from the first to third receivers 55 through 57, as the reception processing signal RX4 to be outputted from the fourth receiver 58. Accordingly, failure determination can be performed by detecting the difference through the comparison between the reception power values.

In this situation, it may be also allowed that the reference power value PB is a fixed value. In this case, the reference power calculation unit 121 stores and outputs a value determined through an experiment or the like. For example, the reference power value PB can be determined by experimentally ascertaining the power values P1, P2, P3, and P4 obtained from the reception processing signals RX1, RX2, RX3, and RX4. Setting the reference power value PB to a fixed value makes it possible that in the case where electric power obtained from a reception processing signal is smaller than the reference power value PB in such a way as to be under a threshold value, the failure determination unit 131 determines that the receiver that has outputted the foregoing reception processing signal has a failure.

The failure detection apparatus 101 performs the failure determination by comparing the reference power value PB with the first to fourth reception power values P1, P2, P3, and P4 obtained from the first to fourth reception processing signals RX1, RX2, RX3, and RX4 that are obtained through processing of respective signals from the first to fourth reception antennas 21, 22, 23, and 24 of the millimeter wave radar 100 by the first to fourth receivers 55, 56, 57, and 58; therefore, a failed receiver can be determined, while neither a complicated calculation nor configuration of a mechanism such as detecting leakage signals from other-channel radars so as to make collaboration is required. Moreover, even in the case where no road surface exists in front of a vehicle, i.e., in the case where the vehicle is surrounded by a wall, in the case where a parking place is surrounded by a field or a river, or in the case where a parking place faces an ocean, a failed receiver can be determined; thus, this method is very significant.

### <Flow of Processing>

FIG. 5 is a flowchart for explaining failure-detection processing at a time when as Embodiment 1, the reference power value is a fixed value. The flow of the processing will be explained.

The processing is started in the step S101. This processing is performed by the millimeter wave radar 100 for four radars, each time one-frame transmission/reception is completed. The state where the millimeter wave radar 100 sequentially emits electric waves and receives reflected waves with regard to the four radars and then all respective reception data pieces of the four radars are obtained will be referred to as a one-frame transmission/reception completion state. It may be allowed that the processing in FIG. 5 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S102 following the step S101, the failure detection apparatus 101 obtains each one frame of the first to fourth reception processing signals RX1, RX2, RX3, and RX4, which are the outputs of the first to fourth receivers 55, 56, 57, and 58. Next, in the step S103, the reference power calculation unit 121 reads out reference power values from a memory. In the present embodiment, the value of the reference power, which has been preliminarily determined through an experiment or the like, is stored in the memory.

In the step S104 following the step S103, the reference power calculation unit 121 transmits the reference power value to the respective comparison units 51, 52, 53, and 54. In the step S105 following the step S104, the first to fourth comparison units 51, 52, 53, and 54 obtain the first to fourth reception power values P1, P2, P3, and P4 from the first to fourth reception processing signals RX1, RX2, RX3, and RX4. The reception power is obtained by raising a signal amplitude to the second power; however, it may be either average power or integrated power over a one-frame period.

In the step S106 following the step S105, the respective comparison units 51, 52, 53, and 54 subtract the calculated reception power values P1, P2, P3, and P4 from the reference power value PB so as to obtain the respective differences D1, D2, D3, and D4 and then transmit them to the failure determination unit 131. In the step S107 following the step S106, the failure determination unit 131 ascertains whether or not any one of the differences D1, D2, D3, and D4 satisfies the equation “Dn >threshold value DT (n=1 through 4)”. In the case where it is determined in the step S108 that such a difference Dn does not exist, the step S108 is followed by the step S110, where the processing is ended.

In the case where it is determined in the step S108 that there exists the nth receiver that makes the equation “Dn > threshold value DT” satisfied, it is determined in the step S109 that the millimeter wave radar has a failure, and a failure flag is set; then, in the step S110, the processing is ended. In the step S109, it may be allowed that because the number “n” of the receiver that has been determined as “failed” is known, the number is also recorded as failure data.

### 2. Embodiment 2

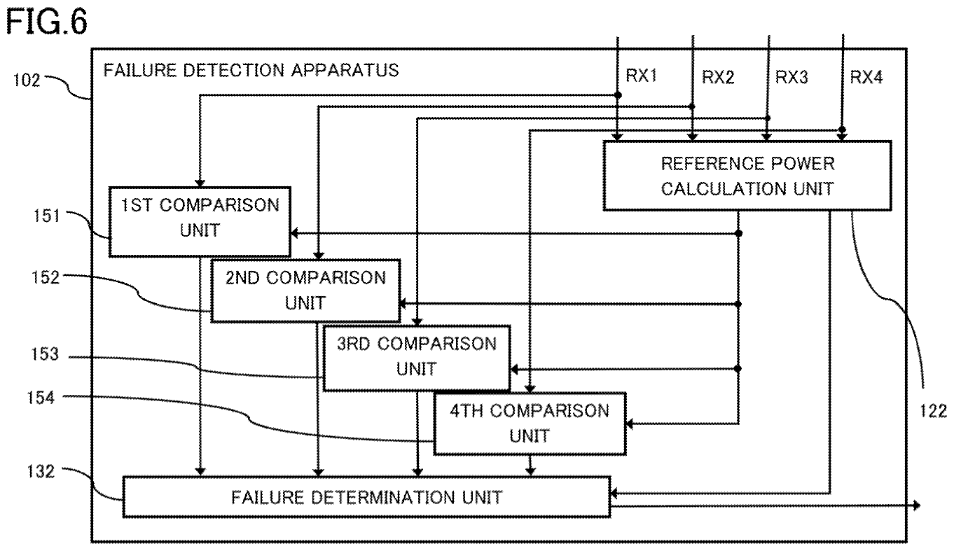

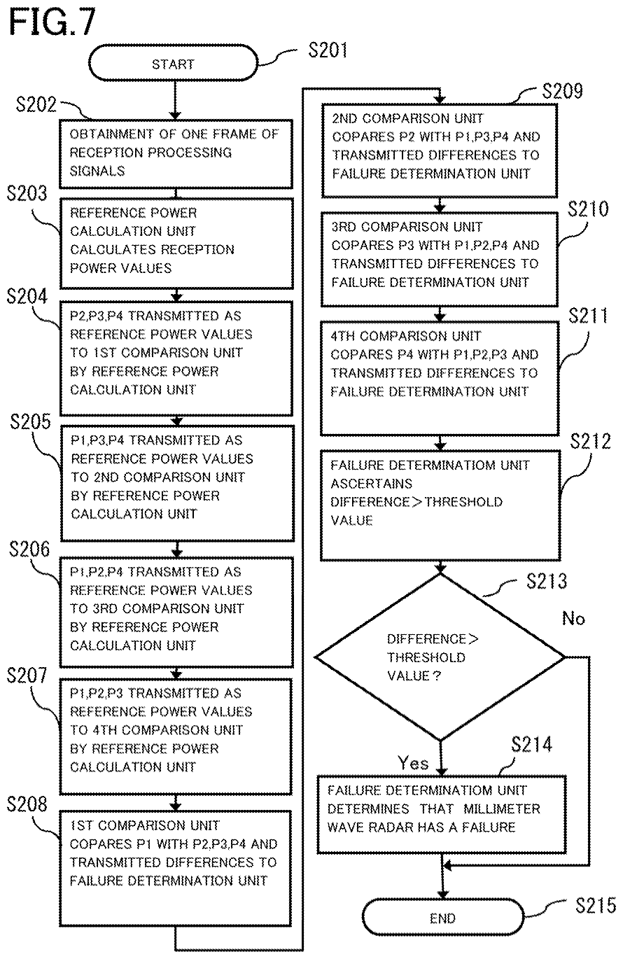

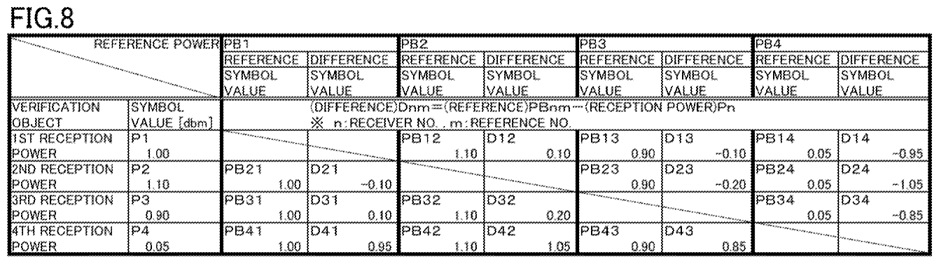

A failure detection apparatus 102 according to Embodiment 2 will be explained. FIG. 6 is a block diagram representing the failure detection apparatus 102 in the millimeter wave radar 100 according to Embodiment 2. FIG. 7 is a flowchart for explaining failure-detection processing according to Embodiment 2. FIG. 8 is a table for explaining a relationship between reception power values and reference power values according to Embodiment 2.

In Embodiment 2, for the reception processing signal of the receiver to be verified, the reference power calculation unit 122 of the failure detection apparatus 102 represented in FIG. 6 directly utilizes, as the reference power values PB, respective reception power values, obtained from the reception processing signals of the other three receivers. The reference power calculation unit transmits these three reference power values to each of comparison units 151, 152, 153, and 154. Each of the comparison units 151, 152, 153, and 154 performs a comparison with each of the three reference power values, i.e., totally three comparisons, and then transmits differences, which are the results of the comparisons, to the failure determination unit 132. The failure determination unit 132 performs a failure determination. The foregoing procedure will be explained.

In Embodiment 2, the reference power calculation unit 122, the first to fourth comparison units 151, 152, 153, and 154, and the failure determination unit 132, which are the constituent elements of the failure detection apparatus 102 represented in FIG. 6, have the same respective hardware configurations of the reference power calculation unit 121, the first to fourth comparison units 51, 52, 53, and 54, and the failure determination unit 131, which are the constituent elements of the failure detection apparatus 101 according to Embodiment 1 represented in FIG. 2. In addition, the configurations of the constituent elements other than the failure detection apparatus 102 in the millimeter wave radar 100 remain the same.

FIG. 7 represents the flowchart for the operation by the failure detection apparatus 102. The processing is started in the step S201. The step S201 is implemented by the millimeter wave radar 100 for the four radars, each time one-frame transmission/reception is completed. It may be allowed that the processing in FIG. 7 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S202, the failure detection apparatus 102 obtains reception processing signals RX1, RX2, RX3, and RX4 for a one-frame period that are the outputs obtained through processing of respective reception signals from the reception antennas 21, 22, 23, and 24 by the receivers 55, 56, 57, and 58. After that, in the step S203, the reception power values P1, P2, P3, and P4 of the respective antennas are obtained from the reception processing signals RX1, RX2, RX3, and RX4 for a one-frame period. The reception power is obtained by raising a signal amplitude to the second power; however, it may be either average power or integrated power over a one-frame period.

In the steps S204 through S207 after the step S203, with regard to the reception processing signal of the receiver to be verified, the reference power calculation unit 122 directly transmits, as the reference power values PB, the respective reception power values, obtained from respective reception processing signals of the other three receivers, to the comparison units.

In the step S204 following the step S203, the reference power calculation unit 122 transmits the second to fourth reception power values P2, P3, and P4, as reference power values PB12, PB13, and PB14, to a first comparison unit 151.

In the step S205 following the step S204, the reference power calculation unit 122 transmits the first, third, and fourth reception power values P1, P3, and P4, as reference power values PB21, PB23, and PB24, to a second comparison unit 152.

In the step S206 following the step S205, the reference power calculation unit 122 transmits the first, second, and fourth reception power values P1, P2, and P4, as reference power values PB31, PB32, and PB34, to a third comparison unit 153.

In the step S207 following the step S206, the reference power calculation unit 122 transmits the first, second, and third reception power values P1, P2, and P3, as reference power values PB41, PB42, and PB43, to a fourth comparison unit 154.

In the steps S208 through S211 after the step S207, each of the comparison units 151, 152, 153, and 154 obtains respective reception power values from the received reception processing signals, compares the reception power values with the three reference power values transmitted from the reference power calculation unit 122, and then transmits the differences to the failure determination unit 132.

In the step S208 following the step S207, the first comparison unit 151 obtains the first reception power value P1 from the received first reception processing signal RX1. The first comparison unit 151 compares the first reception power value P1 with the respective reference power values PB12, PB13, and PB14 transmitted from the reference power calculation unit 122, and then transmits respective differences D12, D13, and D14 to the failure determination unit 132.

In the step S209 following the step S208, the second comparison unit 152 obtains the second reception power value P2 from the received second reception processing signal RX2. The second comparison unit 152 compares the second reception power value P2 with the respective reference power values PB21, PB23, and PB24 transmitted from the reference power calculation unit 122, and then transmits respective differences D21, D23, and D24 to the failure determination unit 132.

In the step S210 following the step S209, the third comparison unit 153 obtains the third reception power value P3 from the received third reception processing signal RX3. The third comparison unit 153 compares the third reception power value P3 with the respective reference power values PB31, PB32, and PB34 transmitted from the reference power calculation unit 122, and then transmits respective differences D31, D32, and D34 to the failure determination unit 132.

In the step S211 following the step S210, the fourth comparison unit 154 obtains the fourth reception power value P4 from the received fourth reception processing signal RX4. The fourth comparison unit 154 compares the fourth reception power value P4 with the respective reference power values PB41, PB42, and PB43 transmitted from the reference power calculation unit 121, and then transmits respective differences D41, D42, and D43 to the failure determination unit 132.

The step S211 is followed by the step S212. In the step S212, the failure determination unit 132 ascertains whether or not there exists any difference, among the differences received from the respective comparison units 151, 152, 153, and 154, that is larger than the predetermined threshold value DT.

In the step S213 following the step S212, the failure determination unit 132 determines whether or not there exists difference data that satisfies the equation “difference Dnm >threshold value DT”. In the case where no such difference data exists, the step S213 is followed by the step S215, where the processing is ended. In the case where in the step S213, there exists difference data that satisfies the equation “difference Dnm >threshold value DT”, the step S213 is followed by the step S214.

In the step S214, because there exists the nth receiver that makes the equation “Dnm >threshold value DT” satisfied, the failure determination unit 132 determines in the step S214 that the millimeter wave radar has a failure, and then sets the failure flag; then, in the step S215, the processing is ended. In the step S214, it may be allowed that because the number “n” of the receiver that has been determined as “failed” is known, the failure determination unit 132 records also the number, as failure data.

FIG. 8 is a table for explaining a relationship between reception power values and reference power values according to Embodiment 2. FIG. 8 represents a case where because the first reception power value P1=1.0 [dBm], the second reception power value P2=1.1 [dBm], the third reception power value P3=0.9 [dBm], and the fourth reception power value P3=0.05 [dBm], the fourth reception power is abnormal.

In Embodiment 2, by directly utilizing, as the reference power values PB, reception power values obtained, with regard to the reception processing signal of the receiver to be verified, from the reception processing signals of the other three receivers, the reference power calculation unit 122 perform the comparison one by one, totally thrice, so as to perform the determination. Accordingly, the reference power values PB for the first reception power value P1 become PB12 (P2=1.1 [dBm]), PB13 (P3=0.9 [dBm]), and PB13 (P3=0.05[dBm]). FIG. 8 represents that the respective differences (D1m=PB1m−P1) between the reception power value P1 (=1.0 [dBm]) and the reference power value PB12, between the reception power value P1 and the reference power value PB13, and between the reception power value P1 and the reference power value PB14 become D12 (=0.1 [dBm]), D13 (=−0.1 [dBm]), and D14 (=−0.95 [dBm]).

The value and the difference D2m of the reference power value PB2m for the second reception power value P2, the value and the difference D3m of the reference power value PB3m for the third reception power value P3, and value and the difference D4m of the reference power value PB4m for the fourth reception power value P4 are similar to the above; thus, the explanations therefor will be omitted. It can be seen that in the case where when the differences are obtained by performing comparisons in this manner, the threshold value is set to 0.5 [dBm], the differences that each exceed the threshold value are the differences D41, D42, and D43 for the fourth reception power value P4 and hence it is determined that the reception processing signal RX4 related to the fourth receiver has a failure. In the present embodiment, the threshold value has been set to 0.5 [dBm]; however, it may be allowed that as the threshold value, an optimal value is determined through an experiment or the like. Moreover, the accuracy of the failure detection can be raised by changing the threshold value for the failure determination unit 132 to perform a failure determination, in accordance with the value of the reference power. For example, it may be allowed that the half of the average value of all the reference power values PB is utilized as the threshold value. In addition, in the present embodiment, in the case where Dnm >threshold value DT, determination of “failure” is made; it may be allowed that |Dnm|>DT is adopted as a determination reference by utilizing the absolute value of Dnm, as a determination subject. In this case, when being compared with the reception power value of the failed receiver, the reception power value of the normal receiver is also determined as “abnormal”; however, when the respective reception power values of the normal receivers are compared with each other, the reception power of the normal receiver is not determined as “abnormal”. Because the number of the determinations “abnormal” becomes larger than that at a time of the normal reception power value, the failed signal can be determined.

Determining the reference power values in such a manner as described above makes it possible that the failure detection is effectively performed by utilizing the nature that even when the reception processing signals change and hence the reception power values change, the level difference between the respective reception power values of the normal receivers does not become large. Moreover, because the failure determination can be performed through simple comparison, without requiring any calculation load at a time of calculation of the average value or the median value of the reception power values, the failure detection apparatus 102 becomes simple and low-cost. In addition, the reception power values of the other receivers are directly utilized as the reference power values PB; however, each of the reference power values PB may be obtained by multiplying the reception power value by a predetermined coefficient.

### 3. Embodiment 3

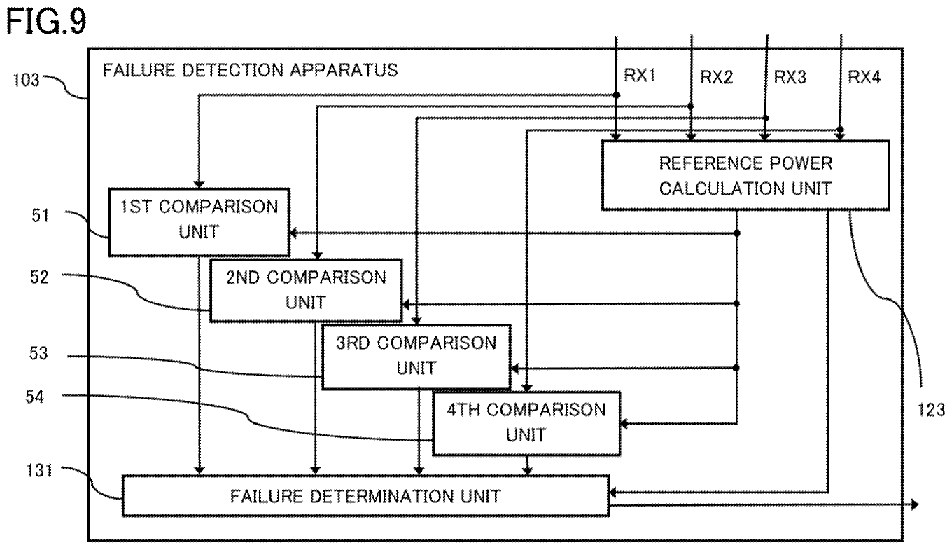

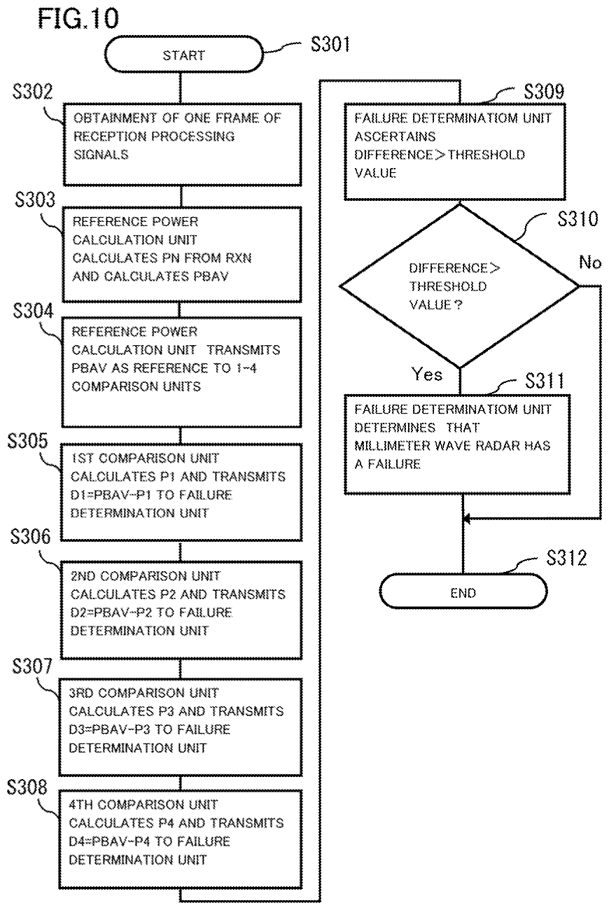

A failure detection apparatus 103 according to Embodiment 3 will be explained. FIG. 9 is a block diagram representing the failure detection apparatus 103 in the millimeter wave radar 100 according to Embodiment 3. FIG. 10 is a flowchart for explaining failure-detection processing according to Embodiment 3.

In Embodiment 3, for the reception processing signal of the receiver to be verified, the reference power calculation unit 123 represented in FIG. 9 determines the reference power value PB, based on the average value of the reception power values obtained from the reception processing signals of all the receivers.

In Embodiment 3, the reference power calculation unit 123, which is a constituent element of the failure detection apparatus 103 represented in FIG. 9, has the same hardware configuration as that of the reference power calculation unit 121, which is the constituent element of the failure detection apparatus 101 according to Embodiment 1 represented in FIG. 2. In addition, the configurations of the constituent elements other than the failure detection apparatus 103 in the millimeter wave radar 100 remain the same.

FIG. 10 represents the flowchart for the operation by the failure detection apparatus 103. The processing is started in the step S301. The step S301 is implemented by the millimeter wave radar 100 for the four radars, each time one-frame transmission/reception is completed. It may be allowed that the processing in FIG. 10 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S302, the failure detection apparatus 103 obtains reception processing signals RX1, RX2, RX3, and RX4 for a one-frame period that are the outputs obtained through processing of respective reception signals from the reception antennas 21, 22, 23, and 24 by the receivers 55, 56, 57, and 58.

In the step S303 following the step S302, the reference power calculation unit 123 obtains reception power values P1, P2, P3, and P4 of the respective antennas from the reception processing signals RX1, RX2, RX3, and RX4 for a one-frame period. The reception power is obtained by raising a signal amplitude to the second power; however, it may be either average power or integrated power over a one-frame period. Then, the reference power calculation unit 123 calculates average power value PBav, which is the average value of the reception power values P1, P2, P3, and P4.

In the step S304 following the step S303, the reference power calculation unit 123 transmits the calculated average power value PBav, as the reference power value, to the first to fourth comparison units 51, 52, 53, and 54.

In the step S305 following the step S304, the first comparison unit 51 calculates the first reception power value P1 from the received first reception processing signal RX1 and then compares the first reception power value P1 with the received reference power value PBay. Then, the first comparison unit 51 transmits a difference D1 (=PBav−P1) to the failure determination unit 131.

In the step S306 following the step S305, the second comparison unit 52 calculates the second reception power value P2 from the received second reception processing signal RX2 and then compares the second reception power value P2 with the received reference power value PBay. Then, the second comparison unit 52 transmits a difference D2 (=PBav−P2) to the failure determination unit 131.

In the step S307 following the step S306, the third comparison unit 53 calculates the third reception power value P3 from the received third reception processing signal RX3 and then compares the third reception power value P3 with the received reference power value PBay. Then, the third comparison unit 53 transmits a difference D3 (=PBav−P3) to the failure determination unit 131.

In the step S308 following the step S307, the fourth comparison unit 54 calculates the fourth reception power value P4 from the received fourth reception processing signal RX4 and then compares the fourth reception power value P4 with the received reference power value PBay. Then, the fourth comparison unit 54 transmits a difference D4 (=PBav−P4) to the failure determination unit 131.

In the step S309 following the step S308, the failure determination unit 131 ascertains whether or not there exists any difference, among the differences received from the respective comparison units 51, 52, 53, and 54, that is larger than the predetermined threshold value DT.

In the step S310 following the step S309, the failure determination unit 131 determines whether or not there exists difference data that satisfies the equation “difference Dn >threshold value DT”. In the case where no such difference data exists, the step S310 is followed by the step S312, where the processing is ended. In the case where in the step S310, there exists difference data that satisfies the equation “difference Dn >threshold value DT”, the step S310 is followed by the step S311.

In the step S311, because there exists the nth receiver that makes the equation “Dn >threshold value DT” satisfied, the failure determination unit 131 determines that the millimeter wave radar has a failure, and then sets the failure flag; then, in the step S312, the processing is ended. In the step S311, it may be allowed that because the number of the receiver that has been determined as “failed” is known, the number is also recorded as failure data.

As described above, for the reception processing signal of the receiver to be verified, the reference power calculation unit 123 determines the reference power value PB, based on the average value of the reception power values obtained from the reception processing signals of all the receivers; therefore, the failure determination can accurately be performed through a simple calculation. Moreover, the accuracy of the failure detection can be raised by changing the threshold value for the failure determination unit 131 to perform a failure determination, in accordance with the average value.

In the foregoing explanation, the comparison units 51, 52, 53, and 54 calculate the respective reception power values P1, P2, P3, and P4 from the respective reception processing signals RX1, RX2, RX3, and RX4; however, the reference power calculation unit 123 also performs these calculations. Accordingly, when the reception power values P1, P2, P3, and P4 calculated by the reference power calculation unit 123 are transmitted to the respective comparison units 51, 52, 53, and 54, it is not required that the comparison units 51, 52, 53, and 54 calculate the respective reception power values P1, P2, P3, and P4, and hence the processing cost can be reduced. In addition, it may be allowed that the absolute value of Dn is compared with the threshold value DT.

In the foregoing explanation, the comparison units 51, 52, 53, and 54 compare the respective reception power values P1, P2, P3, and P4 with the average power value PBav; however, it may be allowed that the comparison units 51, 52, 53, and 54 compare the respective reception power values P1, P2, P3, and P4 with not the average value of all the four reception power values but the average value of the three arbitrary reception power values or the average value of the two arbitrary reception power values. Moreover, the average value is directly utilized as the reference power value PBav; however, it may be allowed that the reference power value PBav is obtained by multiplying the average value by a predetermined coefficient. Furthermore, it may be allowed that the absolute value of Dn is compared with the threshold value DT.

### 4. Embodiment 4

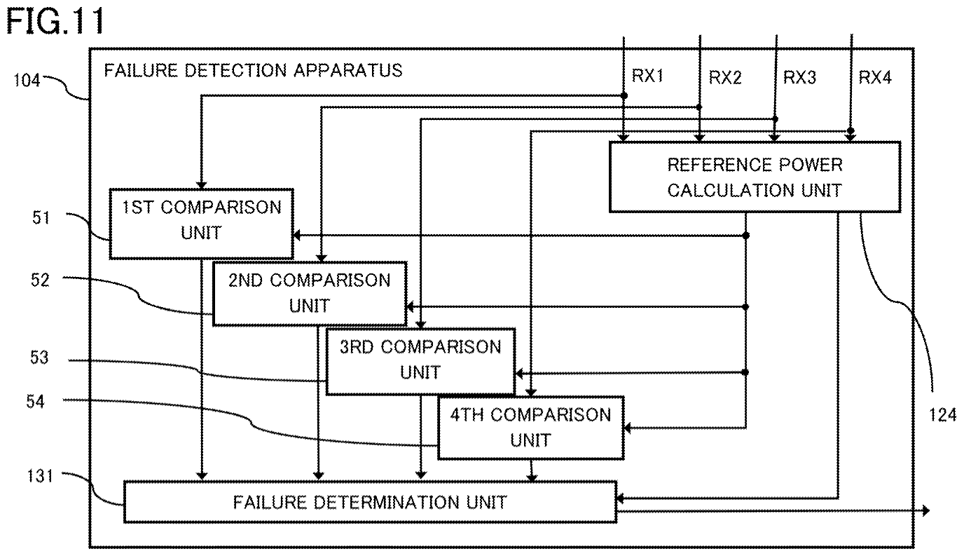

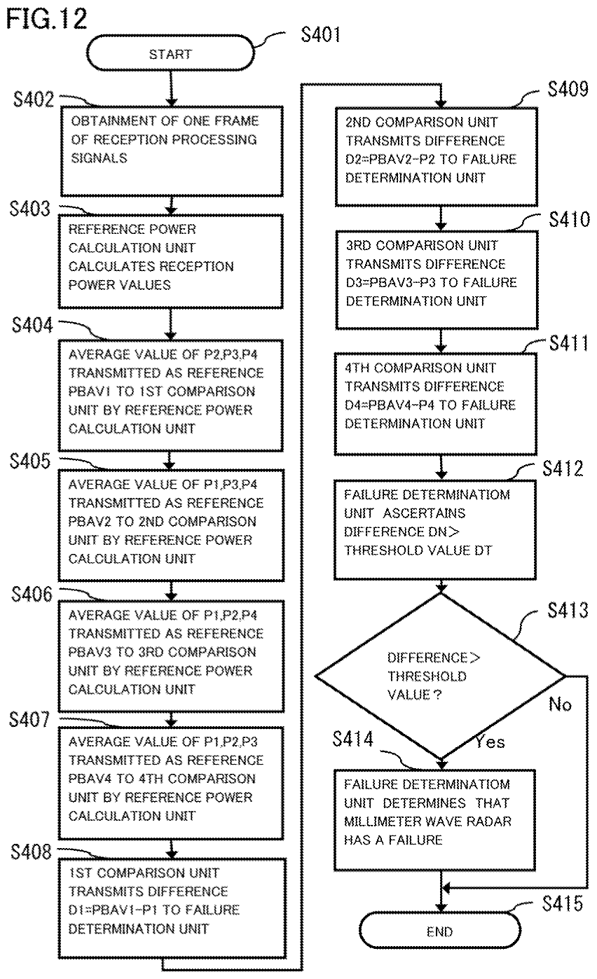

A failure detection apparatus 104 according to Embodiment 4 will be explained. FIG. 11 is a block diagram representing the failure detection apparatus 104 in the millimeter wave radar 100 according to Embodiment 4. FIG. 12 is a flowchart for explaining failure-detection processing according to Embodiment 4.

In Embodiment 4, for the reception processing signal RXn of the receiver to be verified, the reference power calculation unit 124 of the failure detection apparatus 104 represented in FIG. 11 directly utilizes, as the reference power value PBavn, the average value of the respective reception power values obtained from the reception processing signals of the other three receivers. The reference power calculation unit calculates the reference power values PBavn corresponding to the comparison units 51, 52, 53, and 54 and then transmits the reference power values PBavn to the comparison units 51, 52, 53, and 54. The respective comparison units 51, 52, 53, and 54 transmit the differences Dn, which are the results of the comparisons between the reference power value PBavn and the reception power value Pn obtained from the separately received reception processing signals RXn, to the failure determination unit 131. The failure determination unit 131 performs a failure determination. The foregoing procedure will be explained.

In Embodiment 4, the reference power calculation unit 124, which is a constituent element of the failure detection apparatus 104 represented in FIG. 11, has the same hardware configuration as that of the reference power calculation unit 121, which is the constituent element of the failure detection apparatus 101 according to Embodiment 1 represented in FIG. 2. In addition, the configurations of the constituent elements other than the failure detection apparatus 104 in the millimeter wave radar 100 remain

FIG. 12 represents the flowchart for the operation by the failure detection apparatus 104. The processing is started in the step S401. The step S401 is implemented by the millimeter wave radar 100 for the four radars, each time one-frame transmission/reception is completed. It may be allowed that the processing in FIG. 12 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S402 following the step S401, the failure detection apparatus 104 obtains reception processing signals RX1, RX2, RX3, and RX4 for a one-frame period that are the outputs obtained through processing of respective reception signals from the reception antennas 21, 22, 23, and 24 by the receivers 55, 56, 57, and 58.

In the step S403 following the step S402, the reference power calculation unit 124 obtains reception power values P1, P2, P3, and P4 of the respective antennas from the reception processing signals RX1, RX2, RX3, and RX4 for a one-frame period. The reception power is obtained by raising a signal amplitude to the second power; however, it may be either average power or integrated power over a one-frame period.

In the step S404 following the step S403, the reference power calculation unit 124 transmits the average value of the second to fourth reception power values P2, P3, and P4, as the reference power value PBav1, to the first comparison unit 51.

In the step S405 following the step S404, the reference power calculation unit 124 transmits the average value of the first, third, and fourth reception power values P1, P3, and P4, as the reference power value PBav2, to the second comparison unit 52.

In the step S406 following the step S405, the reference power calculation unit 124 transmits the average value of the first, second, and fourth reception power values P1, P2, and P4, as the reference power value PBav3, to the third comparison unit 53.

In the step S407 following the step S406, the reference power calculation unit 124 transmits the average value of the first, second, and third reception power values P1, P2, and P3, as the reference power value PBav4, to the fourth comparison unit 54.

In the step S408 following the step S407, the first comparison unit 51 obtains the first reception power value P1 from the received first reception processing signal RX1. The first comparison unit 51 compares the first reception power value P1 with the reference power value PBav1 transmitted from the reference power calculation unit 124, and then transmits the difference D1 to the failure determination unit 131.

In the step S409 following the step S408, the second comparison unit 52 obtains the second reception power value P2 from the received second reception processing signal RX2. The second comparison unit 52 compares the second reception power value P2 with the reference power value PBav2 transmitted from the reference power calculation unit 124, and then transmits the difference D2 to the failure determination unit 131.

In the step S410 following the step S409, the third comparison unit 53 obtains the third reception power value P3 from the received third reception processing signal RX3. The third comparison unit 53 compares the third reception power value P3 with the reference power value PBav3 transmitted from the reference power calculation unit 124, and then transmits the difference D3 to the failure determination unit 131.

In the step S411 following the step S410, the fourth comparison unit 54 obtains the fourth reception power value P4 from the received fourth reception processing signal RX4. The fourth comparison unit 54 compares the fourth reception power value P4 with the reference power value PBav4 transmitted from the reference power calculation unit 124, and then transmits the difference D4 to the failure determination unit 131.

The step S411 is followed by the step S412. In the step S412, the failure determination unit 131 ascertains whether or not there exists any difference, among the differences received from the respective comparison units 51, 52, 53, and 54, that is larger than the predetermined threshold value DT.

In the step S413 following the step S412, the failure determination unit 131 determines whether or not there exists difference data that satisfies the equation “difference Dn >threshold value DT”. In the case where no such difference data exists, the step S413 is followed by the step S415, where the processing is ended. In the case where in the step S413, there exists difference data that satisfies the equation “difference Dn >threshold value DT”, the step S413 is followed by the step S414.

In the step S414, because there exists the nth receiver that makes the equation “Dn >threshold value DT” satisfied, the failure determination unit 131 determines in the step S414 that the millimeter wave radar has a failure, and then sets the failure flag; then, in the step S415, the processing is ended. In the step S414, it may be allowed that because the number “n” of the receiver that has been determined as “failed” is known, the failure determination unit 131 records also the number, as failure data.

As described above, for the reception processing signal RXn of the receiver to be verified, by adopting, as the reference power value PBavn, the average value of respective reception power values obtained from the reception processing signals of the other three receivers, the reference power calculation unit 124 transmits the reference power value PBavn to the comparison units 51, 52, 53, and 54. The respective comparison units 51, 52, 53, and 54 transmit the differences Dn, which are the results of the comparisons between the reference power value PBavn and the reception power value Pn obtained from the separately received reception processing signals RXn, to the failure determination unit 131. Then the failure determination unit 131 performs the failure determination, based on the difference value Dn. This method makes it possible to perform an accurate failure determination, because the failure determination is performed by comparing the reception power value of a failed receiver with the average value of respective reception power values of the normal three receivers. Moreover, the accuracy of the failure detection can be raised by changing the threshold value for the failure determination unit 131 to perform a failure determination, in accordance with the average value. Furthermore, it may be allowed that the absolute value of Dn is compared with the threshold value DT.

In the foregoing explanation, the comparison units 51, 52, 53, and 54 calculate the respective reception power values P1, P2, P3, and P4 from the respective reception processing signals RX1, RX2, RX3, and RX4; however, the reference power calculation unit 124 also performs these calculations. Accordingly, when the reception power values P1, P2, P3, and P4 calculated by the reference power calculation unit 124 are transmitted to the respective comparison units 51, 52, 53, and 54, it is not required that the comparison units 51, 52, 53, and 54 calculate the respective reception power values P1, P2, P3, and P4, and hence the processing cost can be reduced.

In the foregoing explanation, the comparison units 51, 52, 53, and 54 compare the respective reception power values P1, P2, P3, and P4 with the reference power value PBavn, which is the average value of the respective reception powers obtained from the reception processing signals of the other three receivers; however, it may be allowed that the comparison units 51, 52, 53, and 54 compare the respective reception power values P1, P2, P3, and P4 with not the average value of the other three reception power values but the average value of the other two reception power values. Moreover, the average value is directly utilized as the reference power value PBavn; however, it may be allowed that the reference power value PBavn is obtained by multiplying the average value by a predetermined coefficient.

### 5. Embodiment 5

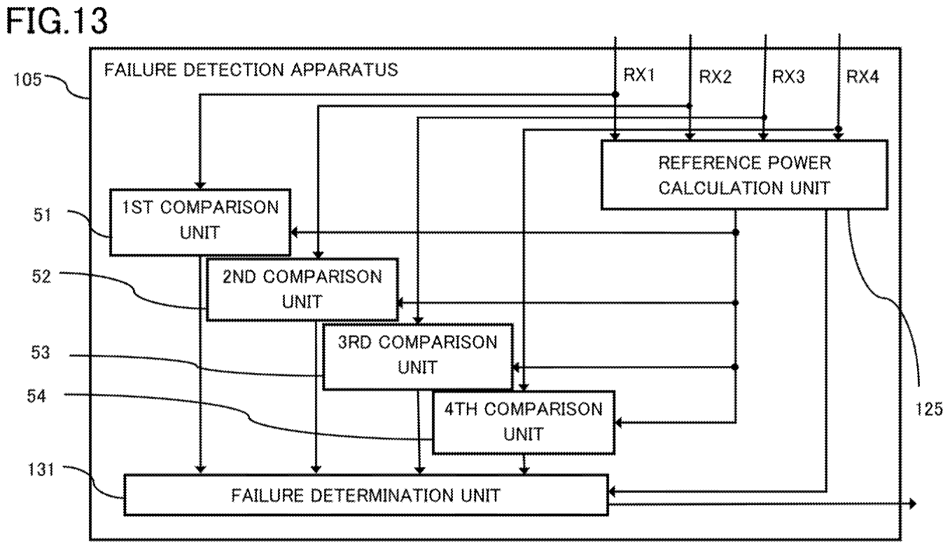

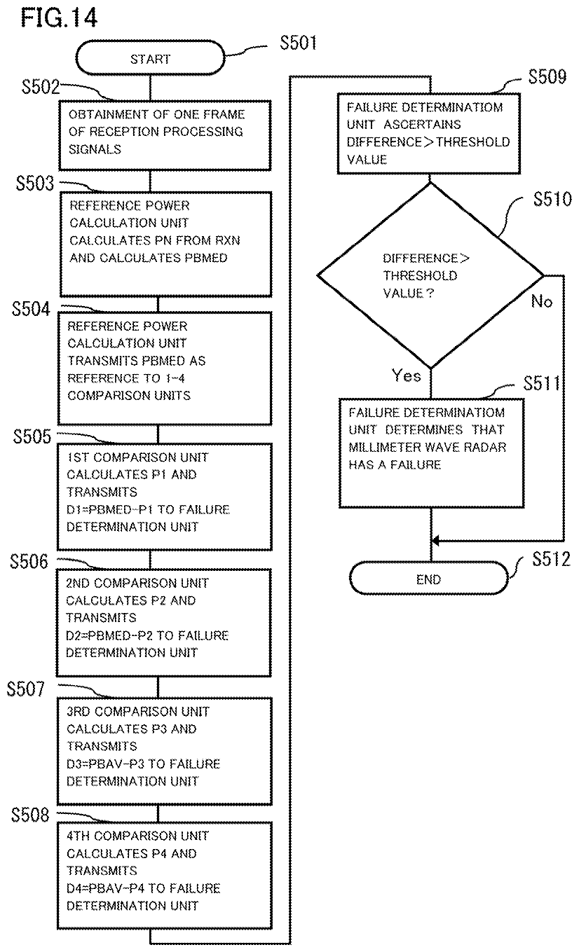

A failure detection apparatus 105 according to Embodiment 5 will be explained. FIG. 13 is a block diagram representing the failure detection apparatus 105 in the millimeter wave radar 100 according to Embodiment 5. FIG. 14 is a flowchart for explaining failure-detection processing according to Embodiment 5.

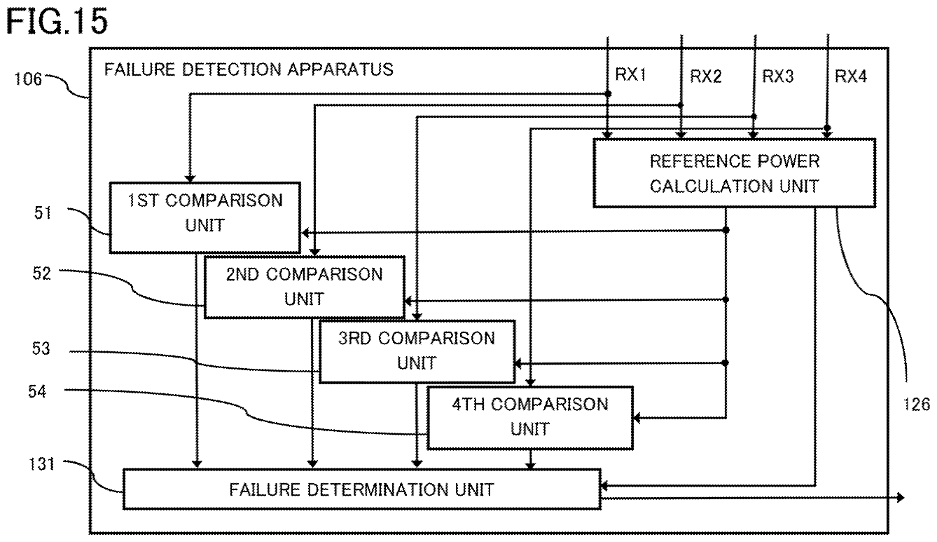

In Embodiment 5, for the reception processing signal of the receiver to be verified, the reference power calculation unit 125 represented in FIG. 15 determines the reference power value PB, based on the median value of the reception power values obtained from the reception processing signals of all the receivers.

In Embodiment 5, the reference power calculation unit 125, which is a constituent element of the failure detection apparatus 105 represented in FIG. 15, has the same hardware configuration as that of the reference power calculation unit 121, which is the constituent element of the failure detection apparatus 101 according to Embodiment 1 represented in FIG. 2. In addition, the configurations of the constituent elements other than the failure detection apparatus 103 in the millimeter wave radar 100 remain the same.

FIG. 14 represents the flowchart for the operation by the failure detection apparatus 105. The processing is started in the step S501. The step S501 is implemented by the millimeter wave radar 100 for the four radars, each time one-frame transmission/reception is completed. It may be allowed that the processing in FIG. 14 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S502, the failure detection apparatus 105 obtains reception processing signals RX1, RX2, RX3, and RX4 for a one-frame period that are the outputs obtained through processing of respective reception signals from the reception antennas 21, 22, 23, and 24 by the receivers 55, 56, 57, and 58.

In the step S503 following the step S502, the reference power calculation unit 125 obtains reception power values P1, P2, P3, and P4 of the respective antennas from the reception processing signals RX1, RX2, RX3, and RX4 for a one-frame period. The reception power is obtained by raising a signal amplitude to the second power; however, it may be either average power or integrated power over a one-frame period. Then, the reference power calculation unit 125 calculates the median value PBmed of the reception power values P1, P2, P3, and P4.

In the step S504 following the step S503, the reference power calculation unit 125 transmits the calculated median value PBmed, as the reference power value, to the first to fourth comparison units 51, 52, 53, and 54.

In the step S505 following the step S504, the first comparison unit 51 calculates the first reception power value P1 from the received first reception processing signal RX1 and then compares the first reception power value P1 with the received reference power value PBmed. Then, the first comparison unit 51 transmits a difference D1 (=PBmed−P1) to the failure determination unit 131.

In the step S506 following the step S505, the second comparison unit 52 calculates the second reception power value P2 from the received second reception processing signal RX2 and then compares the second reception power value P2 with the received reference power value PBmed. Then, the second comparison unit 52 transmits a difference D2 (=PBmed−P2) to the failure determination unit 131.

In the step S507 following the step S506, the third comparison unit 53 calculates the third reception power value P3 from the received third reception processing signal RX3 and then compares the third reception power value P3 with the received reference power value PBmed. Then, the third comparison unit 53 transmits a difference D3 (=PBmed−P3) to the failure determination unit 131.

In the step S508 following the step S507, the fourth comparison unit 54 calculates the fourth reception power value P4 from the received fourth reception processing signal RX4 and then compares the fourth reception power value P4 with the received reference power value PBmed. Then, the fourth comparison unit 54 transmits a difference D4 (=PBmed−P4) to the failure determination unit 131.

In the step S509 following the step S508, the failure determination unit 131 ascertains whether or not there exists any difference, among the differences received from the respective comparison units 51, 52, 53, and 54, that is larger than the predetermined threshold value DT.

In the step S510 following the step S509, the failure determination unit 131 determines whether or not there exists difference data that satisfies the equation “difference Dn >threshold value DT”. In the case where no such difference data exists, the step S510 is followed by the step S512, where the processing is ended. In the case where in the step S510, there exists difference data that satisfies the equation “difference Dn >threshold value DT”, the step S510 is followed by the step S511.

In the step S511, because there exists the nth receiver that makes the equation “Dn >threshold value DT” satisfied, the failure determination unit 131 determines that the millimeter wave radar has a failure, and then sets the failure flag; then, in the step S512, the processing is ended. In the step S511, it may be allowed that because the number of the receiver that has been determined as “failed” is known, the number is also recorded as failure data.

As described above, for the reception processing signal of the receiver to be verified, the reference power calculation unit 125 determines the reference power value PBmed, based on the median value of the reception power values obtained from the reception processing signals of all the receivers; therefore, because being insusceptible to the data of the failed receiver, the failure determination can accurately be performed through a simple calculation. Moreover, the accuracy of the failure detection can be raised by changing the threshold value for the failure determination unit 131 to perform a failure determination, in accordance with the median value. Furthermore, it may be allowed that the absolute value of Dn is compared with the threshold value DT.

In the foregoing explanation, the comparison units 51, 52, 53, and 54 calculate the respective reception power values P1, P2, P3, and P4 from the respective reception processing signals RX1, RX2, RX3, and RX4; however, the reference power calculation unit 125 also performs these calculations. Accordingly, when the reception power values P1, P2, P3, and P4 calculated by the reference power calculation unit 125 are transmitted to the respective comparison units 51, 52, 53, and 54, it is not required that the comparison units 51, 52, 53, and 54 calculate the respective reception power values P1, P2, P3, and P4, and hence the processing cost can be reduced.

In the foregoing explanation, the comparison units 51, 52, 53, and 54 compare the respective reception power values P1, P2, P3, and P4 with the median value PBmed; however, it may be allowed that the comparison units 51, 52, 53, and 54 compare the respective reception power values P1, P2, P3, and P4 with not the median value of all the four reception power values but the median value of the three arbitrary reception power values or the median value of the two arbitrary reception power values. Moreover, the median value is directly utilized as the reference power value PBmed; however, it may be allowed that the reference power value PBmed is obtained by multiplying the median value by a predetermined coefficient.

### 6. Embodiment 6

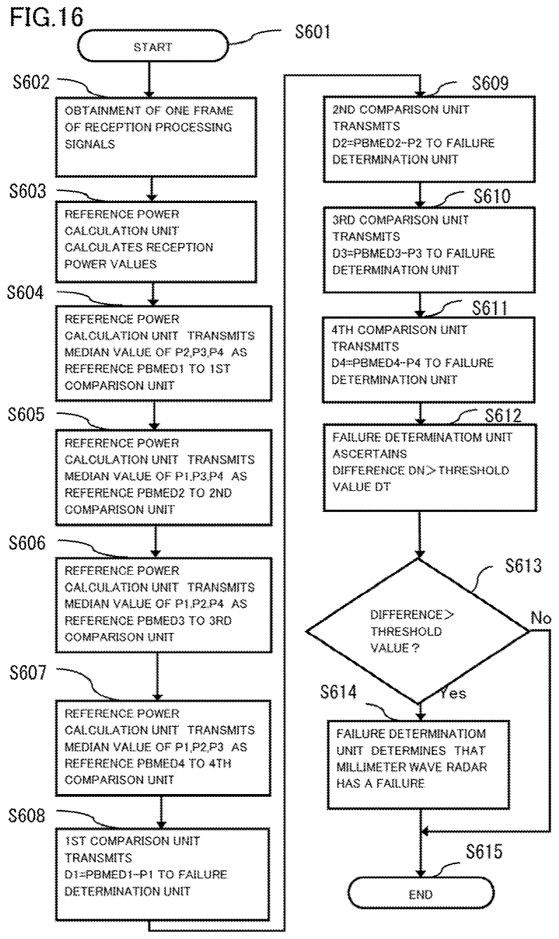

A failure detection apparatus 106 according to Embodiment 6 will be explained. FIG. 15 is a block diagram representing the failure detection apparatus 106 in the millimeter wave radar 100 according to Embodiment 6. FIG. 16 is a flowchart for explaining failure-detection processing according to Embodiment 6.

In Embodiment 6, for the reception processing signal RXn of the receiver to be verified, a reference power calculation unit 126 of the failure detection apparatus 106 represented in FIG. 15 directly utilizes, as the reference power value PBmedn, the median value of the respective reception power values obtained from the reception processing signals of the other three receivers. The reference power calculation unit calculates the reference power values PBmedn corresponding to the comparison units 51, 52, 53, and 54 and then transmits the reference power values PBmedn to the comparison units 51, 52, 53, and 54. The respective comparison units 51, 52, 53, and 54 transmit the differences Dn, which are the results of the comparisons between the reference power values PBmedn and the reception power value Pn obtained from the separately received reception processing signals RXn, to the failure determination unit 131. The failure determination unit 131 performs a failure determination. The foregoing procedure will be explained.

In Embodiment 6, the reference power calculation unit 126, which is a constituent element of the failure detection apparatus 106 represented in FIG. 15, has the same hardware configuration as that of the reference power calculation unit 121, which is the constituent element of the failure detection apparatus 101 according to Embodiment 1 represented in FIG. 2. In addition, the configurations of the constituent elements other than the failure detection apparatus 106 in the millimeter wave radar 100 remain the same.

FIG. 16 represents the flowchart for the operation by the failure detection apparatus 106. The processing is started in the step S601. The step S601 is implemented by the millimeter wave radar 100 for the four radars, each time one-frame transmission/reception is completed. It may be allowed that the processing in FIG. 16 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S602 following the step S601, the failure detection apparatus 106 obtains reception processing signals RX1, RX2, RX3, and RX4 for a one-frame period that are the outputs obtained through processing of respective reception signals from the reception antennas 21, 22, 23, and 24 by the receivers 55, 56, 57, and 58.

In the step S603 following the step S602, the reference power calculation unit 126 obtains reception power values P1, P2, P3, and P4 of the respective antennas from the reception processing signals RX1, RX2, RX3, and RX4 for a one-frame period. The reception power is obtained by raising a signal amplitude to the second power; however, it may be either average power or integrated power over a one-frame period.

In the step S604 following the step S603, the reference power calculation unit 126 transmits the median value of the second to fourth reception power values P2, P3, and P4, as the reference power value PBmed1, to the first comparison unit 51.

In the step S605 following the step S604, the reference power calculation unit 126 transmits the median value of the first, third, and fourth reception power values P1, P3, and P4, as the reference power value PBmed2, to the second comparison unit 52.

In the step S606 following the step S605, the reference power calculation unit 126 transmits the median value of the first, second, and fourth reception power values P1, P2, and P4, as the reference power value PBmed3, to the third comparison unit 53.

In the step S607 following the step S606, the reference power calculation unit 126 transmits the median value of the first, second, and third reception power values P1, P2, and P3, as the reference power value PBmed4, to the fourth comparison unit 54.

In the step S608 following the step S607, the first comparison unit 51 obtains the first reception power value P1 from the received first reception processing signal RX1. The first comparison unit 51 compares the first reception power value P1 with the reference power value PBmed1 transmitted from the reference power calculation unit 126, and then transmits the difference D1 to the failure determination unit 131.

In the step S609 following the step S608, the second comparison unit 52 obtains the second reception power value P2 from the received second reception processing signal RX2. The second comparison unit 52 compares the second reception power value P2 with the reference power value PBmed2 transmitted from the reference power calculation unit 126, and then transmits the difference D2 to the failure determination unit 131.

In the step S610 following the step S609, the third comparison unit 53 obtains the third reception power value P3 from the received third reception processing signal RX3. The third comparison unit 53 compares the third reception power value P3 with the reference power value PBmed3 transmitted from the reference power calculation unit 126, and then transmits the difference D3 to the failure determination unit 131.

In the step S611 following the step S610, the fourth comparison unit 54 obtains the fourth reception power value P4 from the received fourth reception processing signal RX4. The fourth comparison unit 54 compares the fourth reception power value P4 with the reference power value PBmed4 transmitted from the reference power calculation unit 126, and then transmits the difference D4 to the failure determination unit 131.

The step S611 is followed by the step S612. In the step S612, the failure determination unit 131 ascertains whether or not there exists any difference, among the differences received from the respective comparison units 51, 52, 53, and 54, that is larger than the predetermined threshold value DT.

In the step S613 following the step S612, the failure determination unit 131 determines whether or not there exists difference data that satisfies the equation “difference Dn >threshold value DT”. In the case where no such difference data exists, the step S613 is followed by the step S615, where the processing is ended. In the case where in the step S613, there exists difference data that satisfies the equation “difference Dnb >threshold value DT”, the step S613 is followed by the step S614.

In the step S614, because there exists the nth receiver that makes the equation “Dn >threshold value DT” satisfied, the failure determination unit 131 determines in the step S614 that the millimeter wave radar has a failure, and then sets the failure flag; then, in the step S615, the processing is ended. In the step S614, it may be allowed that because the number “n” of the receiver that has been determined as “failed” is known, the failure determination unit 131 records also the number, as failure data.

As described above, for the reception processing signal RXn of the receiver to be verified, by adopting, as the reference power value PBmedn, the median value of respective reception power values obtained from the reception processing signals of the other three receivers, the reference power calculation unit 126 transmits the reference power value PBmedn to the comparison units 51, 52, 53, and 54. The respective comparison units 51, 52, 53, and 54 transmit the differences Dn, which are the results of the comparisons between the reference power values PBmedn and the reception power value Pn obtained from the separately received reception processing signals RXn, to the failure determination unit 131. Then the failure determination unit 131 performs the failure determination, based on the difference value Dn. This method makes it possible that a failure determination that is accurate and insusceptible to the data of the failed receiver is performed, because the failure determination is performed by comparing the reception power value of a failed receiver with the median value of respective reception power values of the normal three receivers. Moreover, the accuracy of the failure detection can be raised by changing the threshold value for the failure determination unit 131 to perform a failure determination, in accordance with the median value. Furthermore, it may be allowed that the absolute value of Dn is compared with the threshold value DT.

In the foregoing explanation, the comparison units 51, 52, 53, and 54 calculate the respective reception power values P1, P2, P3, and P4 from the respective reception processing signals RX1, RX2, RX3, and RX4; however, the reference power calculation unit 126 also performs these calculations. Accordingly, when the reception power values P1, P2, P3, and P4 calculated by the reference power calculation unit 126 are transmitted to the respective comparison units 51, 52, 53, and 54, it is not required that the comparison units 51, 52, 53, and 54 calculate the respective reception power values P1, P2, P3, and P4, and hence the processing cost can be reduced.

In the foregoing explanation, the comparison units 51, 52, 53, and 54 compare the respective reception power values P1, P2, P3, and P4 with the reference power values PBmedn, which is the median value of the respective reception powers obtained from the reception processing signals of the other three receivers; however, it may be allowed that the comparison units 51, 52, 53, and 54 compare the respective reception power values P1, P2, P3, and P4 with not the median value of the other three reception power values but the median value of the other two reception power values. Moreover, the median value is directly utilized as the reference power value PBmedn; however, it may be allowed that the reference power value PBmedn is obtained by multiplying the median value by a predetermined coefficient.

### 7. Embodiment 7

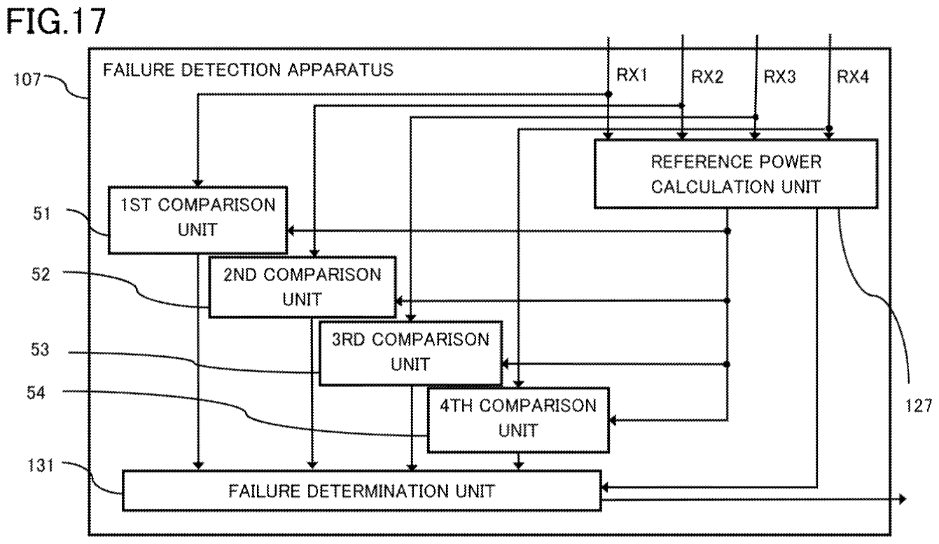

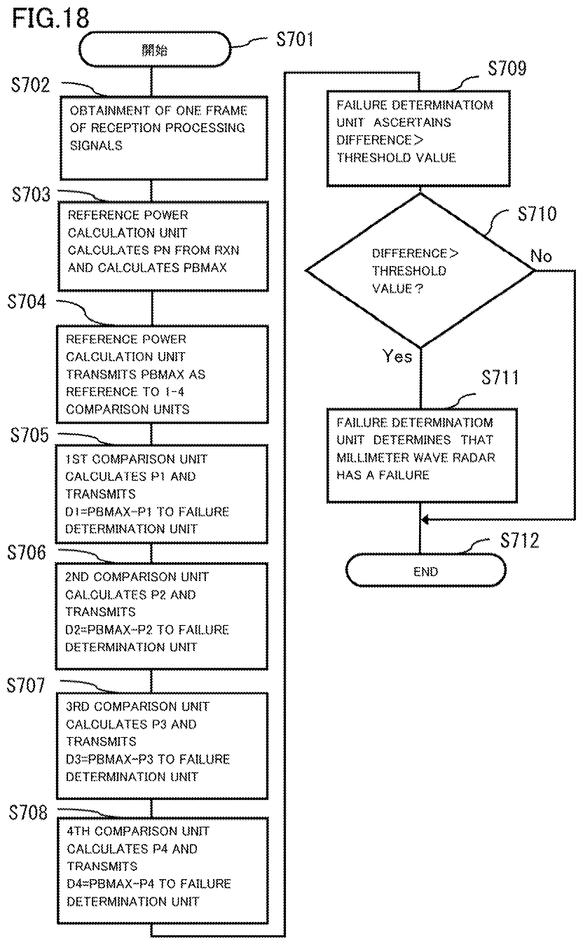

A failure detection apparatus 107 according to Embodiment 7 will be explained. FIG. 17 is a block diagram representing the failure detection apparatus 107 in the millimeter wave radar 100 according to Embodiment 7. FIG. 18 is a flowchart for explaining failure-detection processing according to Embodiment 7.

In Embodiment 7, for the reception processing signal of the receiver to be verified, the reference power calculation unit 127 represented in FIG. 17 determines the reference power value PB, based on the maximum value of the reception power values obtained from the reception processing signals of all the receivers.

In Embodiment 7, the reference power calculation unit 127, which is a constituent element of the failure detection apparatus 107 represented in FIG. 17, has the same hardware configuration as that of the reference power calculation unit 121, which is the constituent element of the failure detection apparatus 101 according to Embodiment 1 represented in FIG. 2. In addition, the configurations of the constituent elements other than the failure detection apparatus 107 in the millimeter wave radar 100 remain the same.

FIG. 18 represents the flowchart for the operation by the failure detection apparatus 107. The processing is started in the step S701. The step S701 is implemented by the millimeter wave radar 100 for the four radars, each time one-frame transmission/reception is completed. It may be allowed that the processing in FIG. 18 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S702, the failure detection apparatus 107 obtains reception processing signals RX1, RX2, RX3, and RX4 for a one-frame period that are the outputs obtained through processing of respective reception signals from the reception antennas 21, 22, 23, and 24 by the receivers 55, 56, 57, and 58.

In the step S703 following the step S702, the reference power calculation unit 127 obtains reception power values P1, P2, P3, and P4 of the respective antennas from the reception processing signals RX1, RX2, RX3, and RX4 for a one-frame period. The reception power is obtained by raising a signal amplitude to the second power; however, it may be either average power or integrated power over a one-frame period. Then, the reference power calculation unit 127 calculates maximum power value PBmax, which is the maximum value of the reception power values P1, P2, P3, and P4.

In the step S704 following the step S703, the reference power calculation unit 127 transmits the calculated maximum power value PBmax, as the reference power, to the first to fourth comparison units 51, 52, 53, and 54.

In the step S705 following the step S704, the first comparison unit 51 calculates the first reception power value P1 from the received first reception processing signal RX1 and then compares the first reception power value P1 with the received reference power value PBmax. Then, the first comparison unit 51 transmits a difference D1 (=PBmax−P1) to the failure determination unit 131.

In the step S706 following the step S705, the second comparison unit 52 calculates the second reception power value P2 from the received second reception processing signal RX2 and then compares the second reception power value P2 with the received reference power value PBmax. Then, the second comparison unit 52 transmits a difference D2 (=PBmax−P2) to the failure determination unit 131.

In the step S707 following the step S706, the third comparison unit 53 calculates the third reception power value P3 from the received third reception processing signal RX3 and then compares the third reception power value P3 with the received reference power value PBmax. Then, the third comparison unit 53 transmits a difference D3 (=PBmax−P3) to the failure determination unit 131.

In the step S708 following the step S707, the fourth comparison unit 54 calculates the fourth reception power value P4 from the received fourth reception processing signal RX4 and then compares the fourth reception power value P4 with the received reference power value PBmax. Then, the fourth comparison unit 54 transmits a difference D4 (=PBmax−P4) to the failure determination unit 131.

In the step S709 following the step S708, the failure determination unit 131 ascertains whether or not there exists any difference, among the differences received from the respective comparison units 51, 52, 53, and 54, that is larger than the predetermined threshold value DT.

In the step S710 following the step S709, the failure determination unit 131 determines whether or not there exists difference data that satisfies the equation “difference Dn >threshold value DT”. In the case where no such difference data exists, the step S710 is followed by the step S712, where the processing is ended. In the case where in the step S710, there exists difference data that satisfies the equation “difference Dn >threshold value DT”, the step S710 is followed by the step S711.

In the step S711, because there exists the nth receiver that makes the equation “Dn >threshold value DT” satisfied, the failure determination unit 131 determines that the millimeter wave radar has a failure, and then sets the failure flag; then, in the step S712, the processing is ended. In the step S711, it may be allowed that because the number “n” of the receiver that has been determined as “failed” is known, the number is also recorded as failure data.

As described above, for the reception processing signal of the receiver to be verified, the reference power calculation unit 127 determines the reference power value PB, based on the maximum value of the reception power values obtained from the reception processing signals of all the receivers; therefore, the failure determination can accurately be performed through a simple calculation. In the case where the phenomenon of a failure in the receiver is limited to a decrease in the reception power, the detection can more accurately be performed. Moreover, the accuracy of the failure detection can be raised by changing the threshold value for the failure determination unit 131 to perform a failure determination, in accordance with the maximum value. Furthermore, it may be allowed that the absolute value of Dn is compared with the threshold value DT.

In the foregoing explanation, the comparison units 51, 52, 53, and 54 calculate the respective reception power values P1, P2, P3, and P4 from the respective reception processing signals RX1, RX2, RX3, and RX4; however, the reference power calculation unit 127 also performs these calculations. Accordingly, when the reception power values P1, P2, P3, and P4 calculated by the reference power calculation unit 127 are transmitted to the respective comparison units 51, 52, 53, and 54, it is not required that the comparison units 51, 52, 53, and 54 calculate the respective reception power values P1, P2, P3, and P4, and hence the processing cost can be reduced.

In the foregoing explanation, the comparison units 51, 52, 53, and 54 compare the respective reception power values P1, P2, P3, and P4 with the maximum power value PBmax; however, it may be allowed that the comparison units 51, 52, 53, and 54 compare the respective reception power values P1, P2, P3, and P4 with not the maximum value of all the four reception power values but the maximum value of the three arbitrary reception power values or the maximum value of the two arbitrary reception power values. Moreover, the maximum value is directly utilized as the reference power value PBmax; however, it may be allowed that the reference power value PBmax is obtained by multiplying the maximum value by a predetermined coefficient.

### 8. Embodiment 8

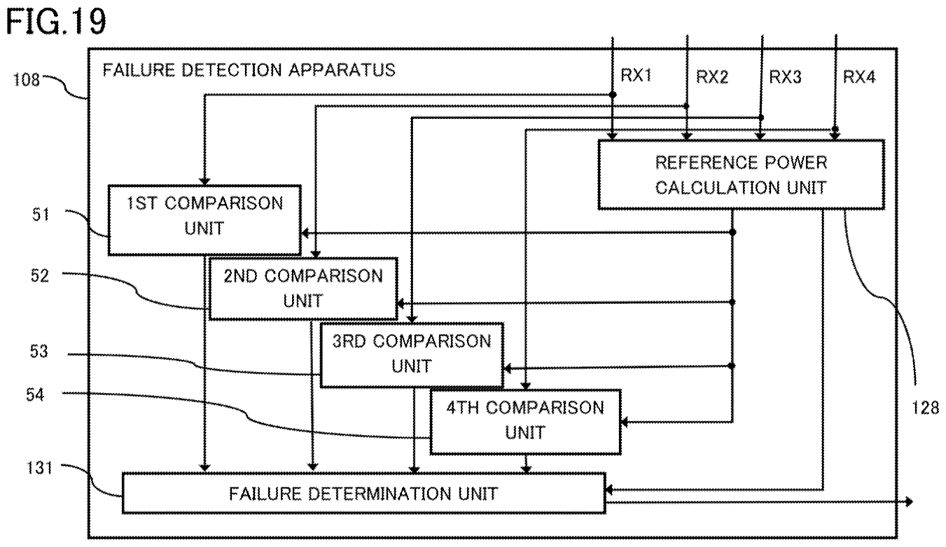

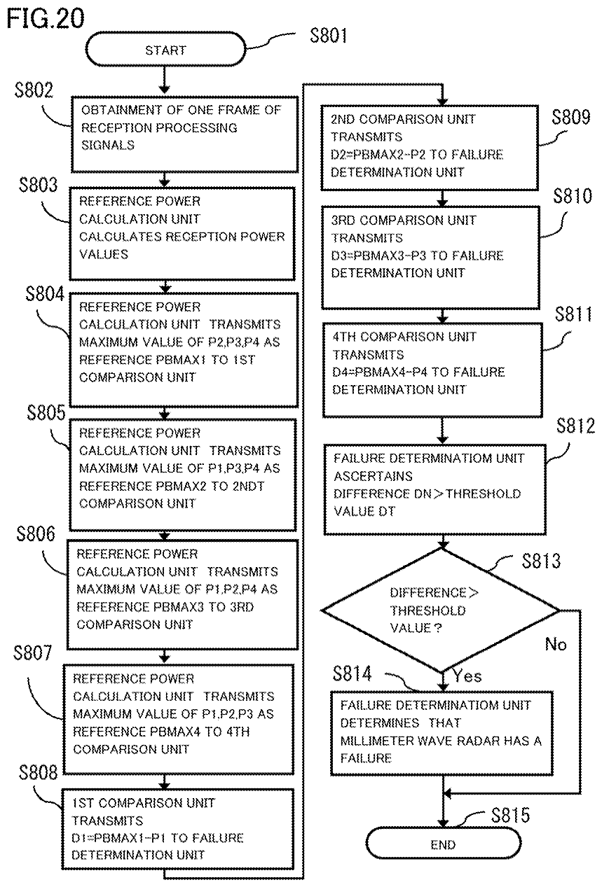

A failure detection apparatus 108 according to Embodiment 8 will be explained. FIG. 19 is a block diagram representing the failure detection apparatus 108 in the millimeter wave radar 100 according to Embodiment 8. FIG. 20 is a flowchart for explaining failure-detection processing according to Embodiment 8.

In Embodiment 8, for the reception processing signal RXn of the receiver to be verified, a reference power calculation unit 128 of the failure detection apparatus 108 represented in FIG. 19 directly utilizes, as the reference power value PBmaxn, the maximum value of the respective reception power values obtained from the reception processing signals of the other three receivers. The reference power calculation unit calculates the reference power values PBmaxn corresponding to the comparison units 51, 52, 53, and 54 and then transmits the reference power values PBmaxn to the comparison units 51, 52, 53, and 54. The respective comparison units 51, 52, 53, and 54 transmit the differences Dn, which are the results of the comparisons between the reference power value PBmaxn and the reception power value Pn obtained from the separately received reception processing signals RXn, to the failure determination unit 131. The failure determination unit 131 performs a failure determination. The foregoing procedure will be explained.

In Embodiment 7, the reference power calculation unit 128, which is a constituent element of the failure detection apparatus 108 represented in FIG. 19, has the same hardware configuration as that of the reference power calculation unit 121, which is the constituent element of the failure detection apparatus 101 according to Embodiment 1 represented in FIG. 2. In addition, the configurations of the constituent elements other than the failure detection apparatus 108 in the millimeter wave radar 100 remain the same.

FIG. 20 represents the flowchart for the operation by the failure detection apparatus 108. The processing is started in the step S801. The step S801 is implemented by the millimeter wave radar 100 for the four radars, each time one-frame transmission/reception is completed. It may be allowed that the processing in FIG. 20 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S802 following the step S801, the failure detection apparatus 108 obtains reception processing signals RX1, RX2, RX3, and RX4 for a one-frame period that are the outputs obtained through processing of respective reception signals from the reception antennas 21, 22, 23, and 24 by the receivers 55, 56, 57, and 58.

In the step S803 following the step S802, the reference power calculation unit 128 obtains reception power values P1, P2, P3, and P4 of the respective antennas from the reception processing signals RX1, RX2, RX3, and RX4 for a one-frame period. The reception power is obtained by raising a signal amplitude to the second power; however, it may be either average power or integrated power over a one-frame period.

In the step S804 following the step S803, the reference power calculation unit 128 transmits the maximum value of the second to fourth reception power values P2, P3, and P4, as the reference power value PBmax1, to the first comparison unit 51.

In the step S805 following the step S804, the reference power calculation unit 128 transmits the maximum value of the first, third, and fourth reception power values P1, P3, and P4, as the reference power value PBmax2, to the second comparison unit 52.

In the step S806 following the step S805, the reference power calculation unit 128 transmits the maximum value of the first, second, and fourth reception power values P1, P2, and P4, as the reference power value PBmax3, to the third comparison unit 53.

In the step S807 following the step S806, the reference power calculation unit 128 transmits the maximum value of the first, second, and third reception power values P1, P2, and P3, as the reference power value PBmax4, to the fourth comparison unit 54.

In the step S808 following the step S807, the first comparison unit 51 obtains the first reception power value P1 from the received first reception processing signal RX1. The first comparison unit 51 compares the first reception power value P1 with the reference power value PBmax1 transmitted from the reference power calculation unit 128, and then transmits the difference D1 to the failure determination unit 131.

In the step S809 following the step S808, the second comparison unit 52 obtains the second reception power value P2 from the received second reception processing signal RX2. The second comparison unit 52 compares the second reception power value P2 with the reference power value PBmax2 transmitted from the reference power calculation unit 128, and then transmits the difference D2 to the failure determination unit 131.

In the step S810 following the step S809, the third comparison unit 53 obtains the third reception power value P3 from the received third reception processing signal RX3. The third comparison unit 53 compares the third reception power value P3 with the reference power value PBmax3 transmitted from the reference power calculation unit 128, and then transmits the difference D3 to the failure determination unit 131.

In the step S811 following the step S810, the fourth comparison unit 54 obtains the fourth reception power value P4 from the received fourth reception processing signal RX4. The fourth comparison unit 54 compares the fourth reception power value P4 with the reference power value PBmax4 transmitted from the reference power calculation unit 128, and then transmits the difference D4 to the failure determination unit 131.

The step S811 is followed by the step S812. In the step S812, the failure determination unit 131 ascertains whether or not there exists any difference, among the differences received from the respective comparison units 51, 52, 53, and 54, that is larger than the predetermined threshold value DT.

In the step S813 following the step S812, the failure determination unit 131 determines whether or not there exists difference data that satisfies the equation “difference Dn >threshold value DT”. In the case where no such difference data exists, the step S813 is followed by the step S815, where the processing is ended. In the case where in the step S813, there exists difference data that satisfies the equation “difference Dn >threshold value DT”, the step S813 is followed by the step S814.

In the step S814, because there exists the nth receiver that makes the equation “Dn >threshold value DT” satisfied, the failure determination unit 131 determines in the step S814 that the millimeter wave radar has a failure, and then sets the failure flag; then, in the step S815, the processing is ended. In the step S814, it may be allowed that because the number “n” of the receiver that has been determined as “failed” is known, the failure determination unit 131 records also the number, as failure data.

As described above, for the reception processing signal RXn of the receiver to be verified, by adopting, as the reference power value PBmaxn, the maximum value of respective reception power values obtained from the reception processing signals of the other three receivers, the reference power calculation unit 128 transmits the reference power value PBmaxn to the comparison units 51, 52, 53, and 54. The respective comparison units 51, 52, 53, and 54 transmit the differences Dn, which are the results of the comparisons between the reference power value PBmaxn and the reception power value Pn obtained from the separately received reception processing signals RXn, to the failure determination unit 131. Then the failure determination unit 131 performs the failure determination, based on the difference value Dn. This method makes it possible to perform an accurate failure determination, because the failure determination is performed by comparing the reception power of a failed receiver with the maximum value of respective reception power values of the normal three receivers. In the case where the phenomenon of a failure in the receiver is limited to a decrease in the reception power, the detection can more accurately be performed. Moreover, the accuracy of the failure detection can be raised by changing the threshold value for the failure determination unit 131 to perform a failure determination, in accordance with the maximum value. Furthermore, it may be allowed that the absolute value of Dn is compared with the threshold value DT.

In the foregoing explanation, the comparison units 51, 52, 53, and 54 calculate the respective reception power values P1, P2, P3, and P4 from the respective reception processing signals RX1, RX2, RX3, and RX4; however, the reference power calculation unit 128 also performs these calculations. Accordingly, when the reception power values P1, P2, P3, and P4 calculated by the reference power calculation unit 128 are transmitted to the respective comparison units 51, 52, 53, and 54, it is not required that the comparison units 51, 52, 53, and 54 calculate the respective reception power values P1, P2, P3, and P4, and hence the processing cost can be reduced.

In the foregoing explanation, the comparison units 51, 52, 53, and 54 compare the respective reception power values P1, P2, P3, and P4 with the reference power value PBmaxn, which is the maximum value of the respective reception powers obtained from the reception processing signals of the other three receivers; however, it may be allowed that the comparison units 51, 52, 53, and 54 compare the respective reception power values P1, P2, P3, and P4 with not the maximum value of the other three reception power values but the maximum value of the other two reception power values. Moreover, the maximum value is directly utilized as the reference power value PBmaxn; however, it may be allowed that the reference power value PBmaxn is obtained by multiplying the maximum value by a predetermined coefficient.

### 9. Embodiment 9

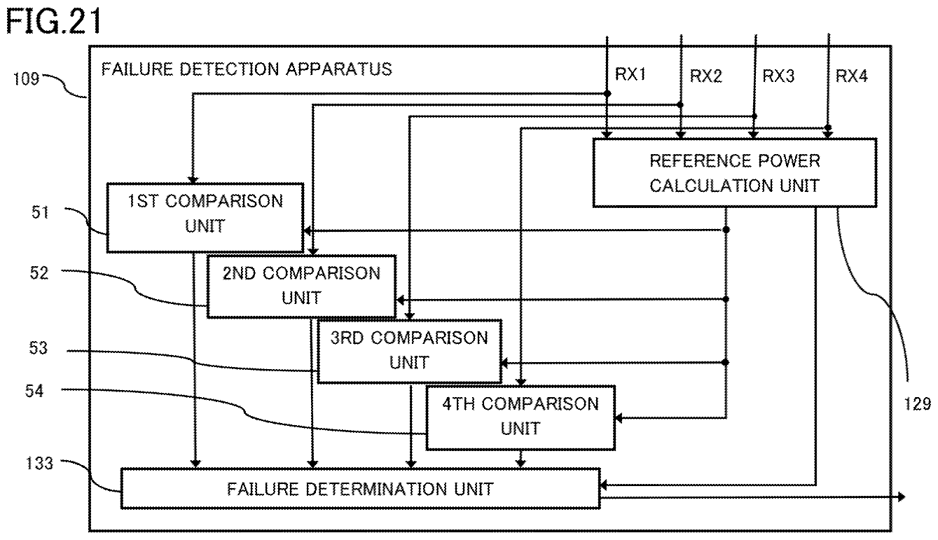

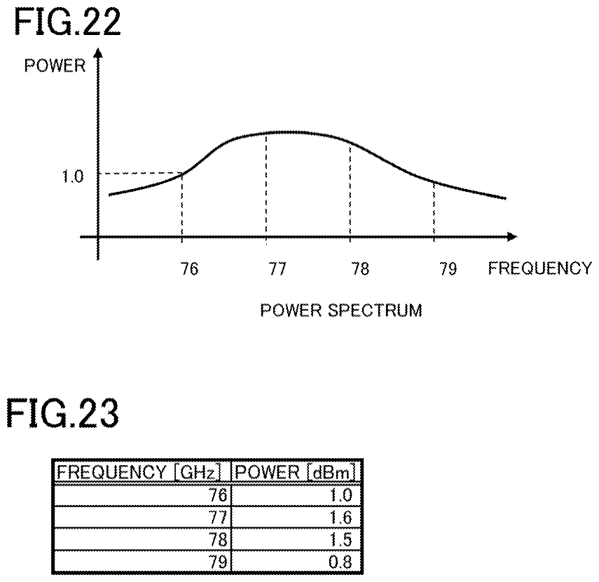

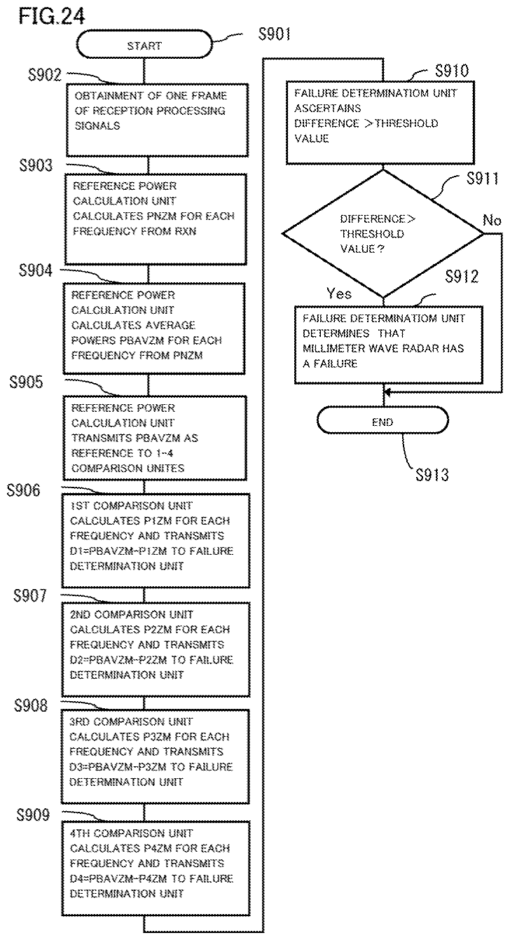

A failure detection apparatus 109 according to Embodiment 9 will be explained. FIG. 21 is a block diagram representing the failure detection apparatus 109 in the millimeter wave radar 100 according to Embodiment 9. FIG. 22 is a chart representing a power spectrum of a reception processing signal in the millimeter wave radar according to Embodiment 9. FIG. 23 is a table representing power values, for frequencies, of the reception processing signal in the millimeter wave radar according to Embodiment 9. FIG. 24 is a flowchart for explaining failure-detection processing according to Embodiment 9.

In Embodiment 9, a reference power calculation unit 129 represented in FIG. 21 determines reference power value PBavzm for each frequency, based on the average value, for each frequency, of the power values of respective reception processing signals of all the receivers. Then, a failure detection is performed by comparing the reception power value Pnzm, for each frequency, of the reception processing signal of each of the receivers with the reference power value PBavzm for each frequency.

FIG. 22 represents an example of the value of the reception power, for each frequency, of a reception processing signal. FIG. 22 represents a power spectrum obtained from a reception signal of each of the receivers. FIG. 23 is a table in which the power spectrum is represented as a power value for each 1 GHz.

FIG. 24 represents a flowchart of the operation by the failure detection apparatus 109 that is performed in Embodiment 9 and is based on the reception power for each frequency. In Embodiment 9, the reference power calculation unit 129, first to fourth comparison units 251, 252, 253, and 254, and a failure determination unit 133, which are the constituent elements of the failure detection apparatus 109 represented in FIG. 21, have the same respective hardware configurations of the reference power calculation unit 121, the first to fourth comparison units 51, 52, 53, and 54, and the failure determination unit 131, which are the constituent elements of the failure detection apparatus 101 according to Embodiment 1 represented in FIG. 2. In addition, the configurations of the constituent elements other than the failure detection apparatus 109 in the millimeter wave radar 100 remain the same.

In the flowchart in FIG. 24, the processing is started in the step S901. The step S901 is implemented by the millimeter wave radar 100 for the four radars, each time one-frame transmission/reception is completed. It may be allowed that the processing in FIG. 24 is implemented not every one-frame transmission/reception but every predetermined time (for example, every 5 ms). In that case, it may be allowed that while assuming that data for a predetermined time (for example, 5 ms) is a one-frame reception signal, the following processing is performed.

In the step S902, the failure detection apparatus 109 obtains reception processing signals RX1, RX2, RX3, and RX4 for a one-frame period that are the outputs obtained through processing of respective reception signals from the reception antennas 21, 22, 23, and 24 by the receivers 55, 56, 57, and 58.

In the step S903 following the step S902, the reference power calculation unit 129 obtains reception power values P1zm, P2zm, P3zm, and P4zm, for each frequency, of the respective receivers from the reception processing signals RX1, RX2, RX3, and RX4 for a one-frame period. The reception power for each frequency is obtained by raising a signal amplitude to the second power; however, it may be either average power or integrated power over a one-frame period.

Next, in the step S904, the reference power calculation unit 129 obtains respective average powers for each frequency from the reception power values P1zm, P2zm, P3zm, and P4zm for each frequency and then utilizes the average power values, as the reference power values PBavzm.

In the step S905 following the step S904, the reference power calculation unit 129 transmits the reference power values PBavzm, which are the average power values for each frequency, to the first to fourth comparison units 251, 252, 253, and 254.

In the step S906 following the step S905, the first comparison unit 251 calculates the reception power value P1zm every first frequency from the received first reception processing signal RX1 and then compares the reception power value P1zm with the received reference power value PBavzm for each frequency. Then, the first comparison unit 251 transmits a difference D1 (=PBavzm−P1m) to the failure determination unit 133.

In the step S907 following the step S906, the second comparison unit 252 calculates the reception power value P2zm every second frequency from the received second reception processing signal RX2 and then compares the reception power value P2zm with the received reference power value PBavzm for each frequency. Then, the second comparison unit 252 transmits a difference D2 (=PBavzm−P2zm) to the failure determination unit 133.

In the step S908 following the step S907, the third comparison unit 253 calculates the reception power value P3zm every third frequency from the received third reception processing signal RX3 and then compares the reception power value P3zm with the received reference power value PBavzm for each frequency. Then, the third comparison unit 253 transmits a difference D3 (=PBavzm−P3zm) to the failure determination unit 133.

In the step S909 following the step S908, the fourth comparison unit 254 calculates the reception power value P4zm every fourth frequency from the received fourth reception processing signal RX4 and then compares the reception power value P4zm with the received reference power value PBavzm for each frequency. Then, the fourth comparison unit 254 transmits a difference D4 (=PBavzm−P4zm) to the failure determination unit 133.

In the step S910 following the step S909, the failure determination unit 133 ascertains whether or not there exists any difference, among the differences D1, D2, D3, and D4 for each frequency received from the respective comparison units 251, 252, 253, and 254, that is larger than the predetermined threshold value DT.

In the step S911 following the step S910, the failure determination unit 131 determines whether or not there exists any difference data for each frequency that satisfies the equation “difference Dnm >threshold value DT”. In the case where no such difference data exists, the step S911 is followed by the step S913, where the processing is ended. In the case where in the step S911, there exists any difference data that satisfies the equation “difference Dnm >threshold value DT”, the step S911 is followed by the step S912.

In the step S912, because there exists the power value, for the frequency m, of the signal of the nth receiver that makes the equation “Dnm >threshold value DT” satisfied, the failure determination unit 131 determines that the millimeter wave radar has a failure, and then sets the failure flag; then, in the step S913, the processing is ended. In the step S912, it may be allowed that because the frequency “m” and the number “n” of the receiver that has been determined as “failed” are known, the number “n” and the frequency “m” are also recorded as failure data.

As described above, for the reception power value, for each frequency, of the reception processing signal of the receiver to be verified, the reference power calculation unit 129 determines the reference power value PBavzm, based on the average value, for each frequency, of the reception power values obtained from the reception processing signals of all the receivers; therefore, the failure determination can accurately be performed because the comparison can be performed for each frequency. Although because a failure is determined for each frequency, the cost therefor is required, the failure can be detected with high accuracy even when part of the antennas or the reception circuits are failed. Moreover, the accuracy of the failure detection can be raised by changing the threshold value for the failure determination unit 133 to perform a failure determination, in accordance with the value of the reference power value PBavzm for each frequency. Furthermore, it may be allowed that the absolute value of Dn is compared with the threshold value DT.

In the foregoing explanation, the comparison units 251, 252, 253, and 254 calculate the respective reception power values P1zm, P2zm, P3zm, and P4zm for each frequency from the respective reception processing signals RX1, RX2, RX3, and RX4; however, the reference power calculation unit 129 also performs these calculations. Accordingly, when the reception power values P1zm, P2zm, P3zm, and P4zm for each frequency calculated by the reference power calculation unit 129 are transmitted to the respective comparison units 251, 252, 253, and 254, it is not required that the comparison units 251, 252, 253, and 254 calculate the respective reception power values P1zm, P2zm, P3zm, and P4zm for each frequency, and hence the processing cost can be reduced.

In the foregoing explanation, the comparison units 251, 252, 253, and 254 compare the respective reception power values P1zm, P2zm, P3zm, and P4zm for each frequency with the average power value PBavzm for each frequency; however, it may be allowed that the comparison units 51, 52, 53, and 54 compare the respective reception power values P1zm, P2zm, P3zm, and P4zm for each frequency with not the average value, for each frequency, of all the four reception power values but the average value, for each frequency, of the three arbitrary reception power values or the average value, for each frequency, of the two arbitrary reception power values. Moreover, the average value for each frequency is directly utilized as the reference power value PBavzm; however, it may be allowed that the reference power value PBavzm is obtained by multiplying the average value for each frequency by a predetermined coefficient.

### 10. Embodiment 10

FIG. 1 represents the millimeter wave radar 100 provided with the failure detection apparatus 101. In Embodiment 1 through 9, the failure detection apparatuses 101 through 109 have been explained. In the case where the millimeter wave radar 100 is provided in an actual vehicle, a failure detection is a requisite function; thus, it is required that a failure detection apparatus is definitely mounted therein. Therefore, it is very significant for the millimeter wave radar 100 that any one of the failure detection apparatuses 101 through 109 that each raise the accuracy of the failure detection and contribute to the cost reduction is mounted therein. The radar apparatus that adopts any one of the failure detection apparatuses 101 through 109 is not limited to a millimeter wave radar; a radar utilizing a frequency such as that of a microwave may be adopted.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present disclosure. For example, there are included the case where at least one constituent element is modified, added, or omitted and the case where at least one constituent element is extracted and then combined with constituent elements of other embodiments.

### DESCRIPTION OF REFERENCE NUMERALS

21: first reception antenna
22: second reception antenna
23: third reception antenna
24: fourth reception antenna
51, 151, 251: first comparison unit
52, 152, 252: second comparison unit
53, 153, 253: third comparison unit
54, 154, 254: fourth comparison unit
55: first receiver
56: second receiver
57: third receiver
58: fourth receiver
101, 102, 103, 104, 105, 106, 107, 108, 109: failure detection apparatus
121, 122, 123, 124, 125, 126, 127, 128, 129: reference power calculation unit
131, 132, 133: failure determination unit
RX1: first reception processing signal
RX2: second reception processing signal
RX3: third reception processing signal
RX4: fourth reception processing signal

1. A failure detection apparatus comprising:
two or more reception antennas;
two or more receivers that are provided for the respective reception antennas and process respective signals received by the reception antennas so as to generate respective reception processing signals; and
a failure determinator that compares a reference power value for a failure determination with a power value obtained from a reception processing signal outputted from each of the receivers so as to perform a failure determination for each of the receivers.

2. The failure detection apparatus according to claim 1, further comprising a reference power calculator that calculates the reference power value, based on the power values obtained from the reception processing signals outputted from the receivers other than the receiver to which a failure determination is applied.

3. The failure detection apparatus according to claim 1, further comprising a reference power calculator that calculates the reference power value, based on an average value of the power values obtained from the reception processing signals outputted from all the receivers.

4. The failure detection apparatus according to claim 2, wherein the reference power calculator calculates the reference power value, based on an average value of the power values obtained from the reception processing signals outputted from the receivers other than the receiver to which a failure determination is applied.

5. The failure detection apparatus according to claim 3, wherein the reference power calculator calculates the reference power value, based on a median value of the power values obtained from the reception processing signals of all the receivers.

6. The failure detection apparatus according to claim 2, wherein the reference power calculator calculates the reference power value, based on a median value of the power values obtained from the reception processing signals outputted from the receivers other than the receiver to which a failure determination is applied.

7. The failure detection apparatus according to claim 3, wherein the reference power calculator calculates the reference power value, based on a maximum value of the power values obtained from the reception processing signals of all the receivers.

8. The failure detection apparatus according to claim 2, wherein the reference power calculator calculates the reference power value, based on a maximum value of the power values obtained from the reception processing signals outputted from the receivers other than the receiver to which a failure determination is applied.

9. The failure detection apparatus according to claim 1, further comprising a reference power calculator that obtains power values, at each frequency, of each of the receivers from the reception processing signal and then calculates reference power values for a failure determination at each frequency, based on the power, at each frequency, of each of the receivers, wherein the failure determinator obtains the power at each of the frequencies from the reception processing signal outputted from each of the receivers and then compares the power value with the reference power value for each of the frequencies so as to perform a failure determination.

10. A radar apparatus having the failure detection apparatus according to claim 1.
